(19) United States
(12) Patent Application Publication
(10) Pub. No.: US 2025/0240142 A1
(43) Pub. Date: Jul. 24, 2025

(54) TECHNIQUES FOR MULTI-CODEWORD COMMUNICATIONS USING CDM GROUP-BASED DMRS PORT MAPPING

(71) Applicant: QUALCOMM Incorporated, San Diego, CA (US)

(72) Inventors: Muhammad Sayed Khairy ABDELGHAFFAR, San Jose, CA (US); Prasanna MADHUSUDHANAN, San Diego, CA (US); Andreas Maximilian SCHENK, Erlangen (DE); Jae Won YOO, San Diego, CA (US); Manish JAIN, San Jose, CA (US); Hari SANKAR, San Diego, CA (US); Alexei Yurievitch GOROKHOV, San Diego, CA (US); Pinar SEN, San Diego, CA (US); Alexandros MANOLAKOS, Athens (GR)

(21) Appl. No.: 18/699,812

(22) PCT Filed: Nov. 18, 2022
(86) PCT No.: PCT/US2022/080179

§ 371 Date: Apr. 9, 2024

(30) Foreign Application Priority Data
Dec. 13, 2021 (GR) 20210100869

(51) Int. Cl. H04L 5/00

(52) U.S. Cl. CPC H04L 5/0051; H04L 5/0016

(57) ABSTRACT

Methods, systems, and devices for wireless communications are described. A user equipment (UE) may receive first control signaling indicating a demodulation reference signal (DMRS) port mapping configuration for a set of antenna port field values. For each antenna port field value, the DMRS port mapping configuration may include a first mapping between a first codeword corresponding to a first transmission-reception point (TRP) and a first code-division multiplexing (CDM) group, and a second mapping between a second codeword corresponding to a second TRP and a second CDM group. The UE may receive second control signaling that indicates an antenna port field value from the set of antenna port field values. The UE may then receive, based on the antenna port field value, first and second DMRSs including the first and second codewords, respectively, via first and second sets of DMRS ports corresponding to the first and second CDM groups, respectively.

### CROSS REFERENCE

The present application is a 371 national stage filing of International PCT Application No. PCT/US2022/080179 by ABDELGHAFFAR et al. entitled “TECHNIQUES FOR MULTI-CODEWORD COMMUNICATIONS USING CDM GROUP-BASED DMRS PORT MAPPING,” filed Nov. 18, 2022; and claims priority to Greece Patent Application No. 20210100869 by ABDELGHAFFAR et al., entitled “TECHNIQUES FOR MULTI-CODEWORD COMMUNICATIONS USING CDM GROUP-BASED DMRS PORT MAPPING,” filed Dec. 13, 2021, each of which is assigned to the assignee hereof, and each of which is expressly incorporated by reference in its entirety herein.

### FIELD OF TECHNOLOGY

The following relates to wireless communications, including techniques for multi-codeword communications using code-division multiplexing (CDM) group-based demodulation reference signal (DMRS) port mapping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may utilize demodulation reference signals (DMRSs) to enable channel estimation between wireless devices, where DMRSs are transmitted using one or more DMRS ports. Each DMRS port may correspond to a respective code-division multiplexing (CDM) group and codeword, where DMRS ports within a given CDM group are orthogonal to one another to enable demodulation at a receiving device. For higher-rank communications (e.g., communications with more layers), two codewords must be used among the layers. However, current codeword-to-DMRS port mapping schemes result in DMRS ports associated with a single CDM group being distributed across both codewords, making the DMRSs inseparable, and therefore unresolvable, at the receiving device.

### SUMMARY

The described techniques relate to improved methods, systems, devices, and apparatuses that support techniques for multi-codeword communications using code-division multiplexing (CDM) group-based demodulation reference signal (DMRS) port mapping. Generally, aspects of the present disclosure support codeword-to-DMRS port mapping configurations which enable DMRS ports which correspond to the same CDM group to be assigned to the same codeword. As a result, DMRS port mapping configurations described herein map DMRS ports to codewords such that DMRS ports corresponding to the same CDM group all correspond to the same codeword. Such techniques prevent DMRS ports for the same CDM group from being distributed across multiple codewords, as is the case with legacy codeword-to-DMRS port mapping schemes.

A method for wireless communication at a user equipment (UE) is described. The method may include receiving, from a base station, first control signaling that indicates a DMRS port mapping configuration for a set of multiple antenna port field values, where, for each antenna port field value, the DMRS port mapping configuration includes a first mapping between a first codeword corresponding to a first transmission-reception point (TRP) and a first CDM group, and a second mapping between a second codeword corresponding to a second TRP and a second CDM group, receiving, from the base station, second control signaling that indicates an antenna port field value from the set of multiple antenna port field values, receiving, from the base station and based on the antenna port field value, a first DMRS including the first codeword, where the first DMRS is received via a first set of DMRS ports corresponding to the first CDM group in accordance with the first mapping, and receiving, from the base station and based on the antenna port field value, a second DMRS including the second codeword, where the second DMRS is received via a second set of DMRS ports corresponding to the second CDM group in accordance with the second mapping.

An apparatus for wireless communication at a UE is described. The apparatus may include a processor, memory coupled with the processor, and instructions stored in the memory. The instructions may be executable by the processor to cause the apparatus to receive, from a base station, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group, receive, from the base station, second control signaling that indicates an antenna port field value from the set of multiple antenna port field values, receive, from the base station and based on the antenna port field value, a first DMRS including the first codeword, where the first DMRS is received via a first set of DMRS ports corresponding to the first CDM group in accordance with the first mapping, and receive, from the base station and based on the antenna port field value, a second DMRS including the second codeword, where the second DMRS is received via a second set of DMRS ports corresponding to the second CDM group in accordance with the second mapping.

Another apparatus for wireless communication at a UE is described. The apparatus may include means for receiving, from a base station, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group, means for receiving, from the base station, second control signaling that indicates an antenna port field value from the set of multiple antenna port field values, means for receiving, from the base station and based on the antenna port field value, a first DMRS including the first codeword, where the first DMRS is received via a first set of DMRS ports corresponding to the first CDM group in accordance with the first mapping, and means for receiving, from the base station and based on the antenna port field value, a second DMRS including the second codeword, where the second DMRS is received via a second set of DMRS ports corresponding to the second CDM group in accordance with the second mapping.

A non-transitory computer-readable medium storing code for wireless communication at a UE is described. The code may include instructions executable by a processor to receive, from a base station, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group, receive, from the base station, second control signaling that indicates an antenna port field value from the set of multiple antenna port field values, receive, from the base station and based on the antenna port field value, a first DMRS including the first codeword, where the first DMRS is received via a first set of DMRS ports corresponding to the first CDM group in accordance with the first mapping, and receive, from the base station and based on the antenna port field value, a second DMRS including the second codeword, where the second DMRS is received via a second set of DMRS ports corresponding to the second CDM group in accordance with the second mapping.

Some examples of the method, apparatuses, and non-transitory computer-readable medium described herein may further include operations, features, means, or instructions for transmitting, to the base station, capability signaling indicating a capability of the UE to communicate with the base station in accordance with the DMRS port mapping configuration, where the first control signaling, the second control signaling, or both, may be received based on the capability signaling.

Some examples of the method, apparatuses, and non-transitory computer-readable medium described herein may further include operations, features, means, or instructions for transmitting, via the capability signaling, an indication of one or more frequency bands, one or more component carriers, or both, which may be associated with the capability of the UE to communicate in accordance with the DMRS port mapping configuration, where the first DMRS, the second DMRS, or both, may be received within the one or more frequency bands, the one or more component carriers, or both.

Some examples of the method, apparatuses, and non-transitory computer-readable medium described herein may further include operations, features, means, or instructions for referencing one or more port mapping tables associated with the DMRS port mapping configuration based on the antenna port field value indicated via the second control signaling and identifying the first set of DMRS ports and the second set of DMRS ports based on referencing the one or more port mapping tables.

Some examples of the method, apparatuses, and non-transitory computer-readable medium described herein may further include operations, features, means, or instructions for determining a first channel estimate associated with a first channel between the UE and the first TRP at the base station based on the first codeword and the first CDM group associated with the first DMRS and determining a second channel estimate associated with a second channel between the UE and the second TRP at the base station based on the second codeword and the second CDM group associated with the second DMRS.

In some examples of the method, apparatuses, and non-transitory computer-readable medium described herein, the first TRP and the second TRP may be spatially separated at the base station, or the first TRP and the second TRP may be co-located at the base station.

In some examples of the method, apparatuses, and non-transitory computer-readable medium described herein, for each antenna port field value of the set of multiple antenna port field values, the DMRS port mapping configuration includes at least one mapping for each of the first and second codewords such that DMRS ports corresponding to the respective first and second CDM groups may be associated with only one of the first or second codewords.

In some examples of the method, apparatuses, and non-transitory computer-readable medium described herein, for the antenna port field value, the DMRS port mapping configuration comprises a third mapping between a third code-division multiplexing group and the first codeword, and the method, apparatuses, and non-transitory computer-readable medium may include further operations, features, means, or instructions for receiving the first DMRS including the first codeword via the first set of DMRS ports corresponding to the first CDM group and the third set of DMRS ports corresponding to the third CDM group in accordance with the first and third mappings, respectively.

Some examples of the method, apparatuses, and non-transitory computer-readable medium described herein may further include operations, features, means, or instructions for receiving, via the second control signaling, an indication of a set of resources for receiving the first DMRS, the second DMRS, or both, where the first DMRS, the second DMRS, or both, may be received within the set of resources.

In some examples of the method, apparatuses, and non-transitory computer-readable medium described herein, the first DMRS may be associated with a first set of wireless communication layers for the first codeword, the second DMRS may be associated with a second set of wireless communication layers for the second codeword, and the first set of wireless communication layers may be different from the second set of wireless communication layers.

In some examples of the method, apparatuses, and non-transitory computer-readable medium described herein, the first control signaling includes a radio resource control (RRC) message, a medium access control-control element (MAC-CE) message, or both and the second control signaling includes a downlink control information (DCI) message.

A method for wireless communication at a base station is described. The method may include transmitting, to a UE, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group, transmitting, to the UE, second control signaling that indicates an antenna port field value from the set of multiple antenna port field values, transmitting, to the UE and based on the antenna port field value, a first DMRS including the first codeword, where the first DMRS is transmitted via a first set of DMRS ports corresponding to the first CDM group in accordance with the first mapping, and transmitting, to the UE and based on the antenna port field value, a second DMRS including the second codeword, where the second DMRS is transmitted via a second set of DMRS ports corresponding to the second CDM group in accordance with the second mapping.

An apparatus for wireless communication at a base station is described. The apparatus may include a processor, memory coupled with the processor, and instructions stored in the memory. The instructions may be executable by the processor to cause the apparatus to transmit, to a UE, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group, transmit, to the UE, second control signaling that indicates an antenna port field value from the set of multiple antenna port field values, transmit, to the UE and based on the antenna port field value, a first DMRS including the first codeword, where the first DMRS is transmitted via a first set of DMRS ports corresponding to the first CDM group in accordance with the first mapping, and transmit, to the UE and based on the antenna port field value, a second DMRS including the second codeword, where the second DMRS is transmitted via a second set of DMRS ports corresponding to the second CDM group in accordance with the second mapping.

Another apparatus for wireless communication at a base station is described. The apparatus may include means for transmitting, to a UE, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group, means for transmitting, to the UE, second control signaling that indicates an antenna port field value from the set of multiple antenna port field values, means for transmitting, to the UE and based on the antenna port field value, a first DMRS including the first codeword, where the first DMRS is transmitted via a first set of DMRS ports corresponding to the first CDM group in accordance with the first mapping, and means for transmitting, to the UE and based on the antenna port field value, a second DMRS including the second codeword, where the second DMRS is transmitted via a second set of DMRS ports corresponding to the second CDM group in accordance with the second mapping.

A non-transitory computer-readable medium storing code for wireless communication at a base station is described. The code may include instructions executable by a processor to transmit, to a UE, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group, transmit, to the UE, second control signaling that indicates an antenna port field value from the set of multiple antenna port field values, transmit, to the UE and based on the antenna port field value, a first DMRS including the first codeword, where the first DMRS is transmitted via a first set of DMRS ports corresponding to the first CDM group in accordance with the first mapping, and transmit, to the UE and based on the antenna port field value, a second DMRS including the second codeword, where the second DMRS is transmitted via a second set of DMRS ports corresponding to the second CDM group in accordance with the second mapping.

Some examples of the method, apparatuses, and non-transitory computer-readable medium described herein may further include operations, features, means, or instructions for receiving, from the UE, capability signaling indicating a capability of the UE to communicate with the base station in accordance with the DMRS port mapping configuration, where the first control signaling, the second control signaling, or both, may be transmitted based on the capability signaling.

Some examples of the method, apparatuses, and non-transitory computer-readable medium described herein may further include operations, features, means, or instructions for receiving, via the capability signaling, an indication of one or more frequency bands, one or more component carriers, or both, which may be associated with the capability of the UE to communicate in accordance with the DMRS port mapping configuration, where the first DMRS, the second DMRS, or both, may be transmitted within the one or more frequency bands, the one or more component carriers, or both.

Some examples of the method, apparatuses, and non-transitory computer-readable medium described herein may further include operations, features, means, or instructions for referencing one or more port mapping tables associated with the DMRS port mapping configuration based on the antenna port field value and identifying the first set of DMRS ports and the second set of DMRS ports based on referencing the one or more port mapping tables.

In some examples of the method, apparatuses, and non-transitory computer-readable medium described herein, where the first TRP and the second TRP may be spatially separated at the base station and where the first TRP and the second TRP may be co-located at the base station.

In some examples of the method, apparatuses, and non-transitory computer-readable medium described herein, for each antenna port field value of the set of multiple antenna port field values, the DMRS port mapping configuration includes at least one mapping for each of the first and second codewords such that DMRS ports corresponding to the respective first and second CDM groups may be associated with only one of the first or second codewords.

In some examples of the method, apparatuses, and non-transitory computer-readable medium described herein, for the antenna port field value, the DMRS port mapping configuration comprises a third mapping between a third code-division multiplexing group and the first codeword, and the method, apparatuses, and non-transitory computer-readable medium may include further operations, features, means, or instructions for transmitting the first DMRS including the first codeword via the first set of DMRS ports corresponding to the first CDM group and the third set of DMRS ports corresponding to the third CDM group in accordance with the first and third mappings, respectively.

Some examples of the method, apparatuses, and non-transitory computer-readable medium described herein may further include operations, features, means, or instructions for transmitting, via the second control signaling, an indication of a set of resources for receiving the first DMRS, the second DMRS, or both, where the first DMRS, the second DMRS, or both, may be transmitted within the set of resources.

In some examples of the method, apparatuses, and non-transitory computer-readable medium described herein, the first DMRS may be associated with a first set of wireless communication layers for the first codeword, the second DMRS may be associated with a second set of wireless communication layers for the second codeword, and the first set of wireless communication layers may be different from the second set of wireless communication layers.

In some examples of the method, apparatuses, and non-transitory computer-readable medium described herein, the first control signaling includes a RRC message, a MAC-CE message, or both and the second control signaling includes a DCI message.

### BRIEF DESCRIPTION OF THE DRAWINGS

FIG. 1 illustrates an example of a wireless communications system that supports techniques for multi-codeword communications using code-division multiplexing (CDM) group-based demodulation reference signal (DMRS) port mapping in accordance with aspects of the present disclosure.

FIG. 2 illustrates an example of a wireless communications system that supports techniques for multi-codeword communications using CDM group-based DMRS port mapping in accordance with aspects of the present disclosure.

FIG. 3 illustrates an example of a DMRS port mapping configuration that supports techniques for multi-codeword communications using CDM group-based DMRS port mapping in accordance with aspects of the present disclosure.

FIG. 4 illustrates an example of a DMRS port mapping configuration that supports techniques for multi-codeword communications using CDM group-based DMRS port mapping in accordance with aspects of the present disclosure.

FIG. 5 illustrates an example of a process flow that supports techniques for multi-codeword communications using CDM group-based DMRS port mapping in accordance with aspects of the present disclosure.

FIGS. 6 and 7 show block diagrams of devices that support techniques for multi-codeword communications using CDM group-based DMRS port mapping in accordance with aspects of the present disclosure.

FIG. 8 shows a block diagram of a communications manager that supports techniques for multi-codeword communications using CDM group-based DMRS port mapping in accordance with aspects of the present disclosure.

FIG. 9 shows a diagram of a system including a device that supports techniques for multi-codeword communications using CDM group-based DMRS port mapping in accordance with aspects of the present disclosure.

FIGS. 10 and 11 show block diagrams of devices that support techniques for multi-codeword communications using CDM group-based DMRS port mapping in accordance with aspects of the present disclosure.

FIG. 12 shows a block diagram of a communications manager that supports techniques for multi-codeword communications using CDM group-based DMRS port mapping in accordance with aspects of the present disclosure.

FIG. 13 shows a diagram of a system including a device that supports techniques for multi-codeword communications using CDM group-based DMRS port mapping in accordance with aspects of the present disclosure.

FIGS. 14 through 17 show flowcharts illustrating methods that support techniques for multi-codeword communications using CDM group-based DMRS port mapping in accordance with aspects of the present disclosure.

### DETAILED DESCRIPTION

Some wireless communications systems may utilize demodulation reference signals (DMRSs) to enable channel estimation between wireless devices, where DMRSs are transmitted using one or more DMRS ports. Each DMRS port may correspond to a respective code-division multiplexing (CDM) group and codeword, where DMRS ports within a given CDM group are orthogonal to one another to enable demodulation at a receiving device. For lower-rank communications (e.g., communications with fewer layers), DMRS signals may be transmitted using a single codeword. Comparatively, for higher-rank communications (e.g., communications with more layers), two codewords must be used among the layers. However, current codeword-to-DMRS port mapping schemes result in DMRS ports associated with a single CDM group being distributed across both codewords. As such, in cases where a transmitting device transmits first and second DMRS signals for first and second codewords, both DMRS signals will include DMRS ports corresponding to the same CDM group. As such, a receiving device will be unable to separate/resolve the respective DMRS signals, and will therefore be unable to perform effective channel estimation using the DMRS signals.

Accordingly, aspects of the present disclosure are directed to codeword-to-DMRS port mapping configurations which enable DMRS ports which correspond to the same CDM group to be assigned to the same codeword. As a result, DMRS port mapping configurations described herein map DMRS ports to codewords such that DMRS ports corresponding to the same CDM group all correspond to the same codeword. Such techniques prevent DMRS ports for the same CDM group from being distributed across multiple codewords, as is the case with legacy codeword-to-DMRS port mapping schemes, and thereby enable DMRS signals to be resolved and decoded at the receiving device.

For example, a UE may transmit control signaling indicating that it is capable of communicating in accordance with new DMRS port mapping configurations, and a base station may indicate (e.g., via radio resource control (RRC) signaling) a DMRS port mapping configuration in response to the control signaling. In such cases, the DMRS port mapping configuration may define mappings between codewords and DMRS ports corresponding to a respective CDM group for each antenna port field value. Subsequently, the base station may indicate (e.g., via downlink control information (DCI)) an antenna port field value for DMRS signals, and the may UE identify which DMRS ports are to be used based on the DMRS port mapping configuration and the indicated antenna port field value. The UE may then receive the DMRS signals associated with the respective codewords using the identified DMRS ports. In such cases, multiple DMRSs may be transmitted via multiple transmission-reception points (TRPs) at the base station using the respective codewords, where the DMRS port mapping configuration enables the DMRSs corresponding to the respective codewords to be efficiently separated and decoded at the UE.

Aspects of the disclosure are initially described in the context of wireless communications systems. Additional aspects of the disclosure are described in the context of example DMRS port mapping configurations and an example process flow. Aspects of the disclosure are further illustrated by and described with reference to apparatus diagrams, system diagrams, and flowcharts that relate to techniques for multi-codeword communications using CDM group-based DMRS port mapping.

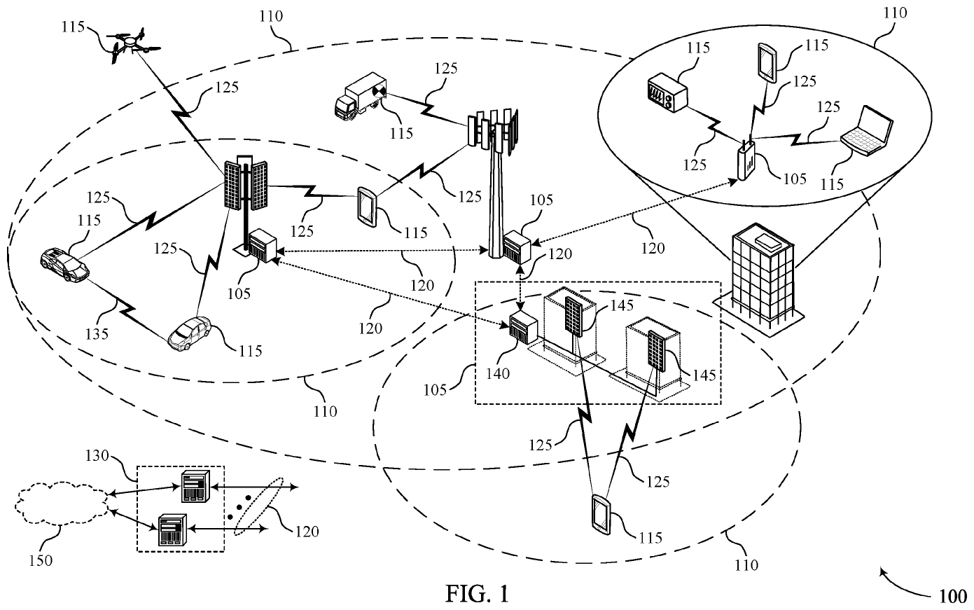

FIG. 1 illustrates an example of a wireless communications system 100 that supports techniques for multi-codeword communications using CDM group-based DMRS port mapping in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some aspects, the UEs 115 and the base stations 105 of the wireless communications system 100 may support codeword-to-DMRS port mapping configurations which enable DMRS ports which correspond to the same CDM group to be assigned to the same codeword. As a result, DMRS port mapping configurations described herein map DMRS ports to codewords such that DMRS ports corresponding to the same CDM group all correspond to the same codeword. Such techniques prevent DMRS ports for the same CDM group from being distributed across multiple codewords, as is the case with legacy codeword-to-DMRS port mapping schemes, and thereby enable DMRS signals to be resolved and decoded at the receiving device.

For example, a UE 115 of the wireless communications system 100 may transmit control signaling indicating that it is capable of communicating in accordance with new DMRS port mapping configurations, and a base station 105 may indicate (e.g., via RRC signaling) a DMRS port mapping configuration in response to the control signaling. In such cases, the DMRS port mapping configuration may define mappings between codewords and DMRS ports corresponding to a respective CDM group for each antenna port field value. Subsequently, the base station 105 may indicate (e.g., via DCI) an antenna port field value for DMRS signals, and the may UE 115 identify which DMRS ports are to be used based on the DMRS port mapping configuration and the indicated antenna port field value. The UE 115 may then receive the DMRS signals associated with the respective codewords using the identified DMRS ports. In such cases, multiple DMRSs may be transmitted via multiple TRPs at the base station 105 using the respective codewords, where the DMRS port mapping configuration enables the DMRSs corresponding to the respective codewords to be efficiently separated and decoded at the UE 115.

Techniques described herein may enable mTRP communications using multiple codewords. In particular, the DMRS port mapping configurations described herein may map DMRS ports corresponding to respective CDM groups to individual codewords so that DMRSs for the respective codewords which are transmitted using different TRPs may be separable at the receiver device. Accordingly, by enabling mTRP DMRS transmissions associated with multiple codewords to be efficiently decoded at receiver devices, techniques described herein may facilitate mTRP channel estimation at the receiver device, which may facilitate more efficient and reliable wireless communications.

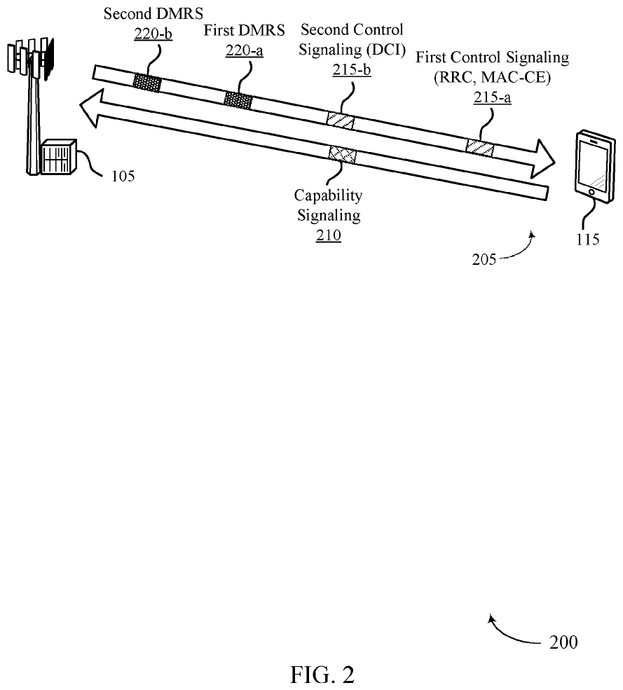

FIG. 2 illustrates an example of a wireless communications system 200 that supports techniques for multi-codeword communications using CDM group-based DMRS port mapping in accordance with aspects of the present disclosure. In some examples, wireless communications system 200 may implement, or be implemented by, aspects of wireless communications system 100. For example, wireless communications system 200 may support DMRS port mapping configurations for multi-codeword communications using CDM group-based DMRS port mapping, as described in FIG. 1.

The wireless communications system 200 may include a base station 105 and a UE 115, which may be examples base stations 105 and UEs 115 as described with reference to FIG. 1. The UE 115 may communicate with the base station 105 using a communication link 205, which may be an example of an NR or LTE link between the UE 115 and the base station 105. In some cases, the communication link 205 between the UE 115 and the base station 105 may include an example of an access link (e.g., Uu link) which may include a bi-directional link that enables both uplink and downlink communication. For example, the UE 115 may transmit uplink signals, such as uplink control signals or uplink data signals (e.g., physical uplink shared channel (PUSCH) transmissions), to the base station 105 using the communication link 205 and the base station 105 may transmit downlink signals, such as downlink control signals or downlink data signals, to the UE 115 using the communication link 205.

As noted previously herein, some wireless communications systems utilize DMRSs to enable channel estimation between wireless devices. DMRSs may be transmitted in accordance with one or more DMRS ports from a set of candidate DMRS ports. Each DMRS port may correspond to a respective CDM group and codeword, where DMRS ports within a given CDM group are orthogonal to one another to enable demodulation at a receiving device. Some wireless communications systems only support two separate DMRS configurations, which may be referred to as DMRS Type 1 (e.g., config-1) and DMRS Type 2 (e.g., config-2). In general, higher quantities of orthogonal DMRS ports which are used/enabled may provide for higher quantities of wireless devices (e.g., UEs) to utilize the time/frequency resources. The quantity of orthogonal DMRS ports which are supported may be based on the quantity of frequency domain orthogonal cover codes (FD-OCCs) which are enabled. Some wireless communications systems support only up to two FD-OCCs (e.g., N=2) which may enable up to 12 orthogonal DMRS ports using DMRS Type 2 (e.g., configuration type-2) DMRS with two symbols (e.g., two FD-OCCs, or N=2). Comparatively, some wireless communications systems may support up to 8 orthogonal DMRS ports when using configuration type-1 DMRS.

In some aspects, codewords associated with DMRS signals may be mapped to respective layers for DMRSs. For example, a codeword-to-layer mapping configuration for DMRS spatial multiplexing is shown in Table 1 below:

TABLE 1
Codeword-to-Layer Mapping for Spatial Multiplexing

| # of | # of | Codeword-to-layer mapping | |
|---|---|---|---|
| layers | codewords | i = 0, 1, . . . , M_{symb}^{layer} − 1 | |
| 1 | 1 | x⁽⁰⁾(i) = d⁽⁰⁾(i) | M_{symb}^{layer} = M_{symb}⁽⁰⁾ |
| 2 | 1 | x⁽⁰⁾(i) = d⁽⁰⁾(2i) | M_{symb}^{layer} = M_{symb}⁽⁰⁾/2 |
| | | x⁽¹⁾(i) = d⁽⁰⁾(2i + 1) | |
| 3 | 1 | x⁽⁰⁾(i) = d⁽⁰⁾(3i) | M_{symb}^{layer} = M_{symb}⁽⁰⁾/3 |
| | | x⁽¹⁾(i) = d⁽⁰⁾(3i + 1) | |
| | | x⁽²⁾(i) = d⁽⁰⁾(3i + 2) | |
| 4 | 1 | x⁽⁰⁾(i) = d⁽⁰⁾(4i) | M_{symb}^{layer} = M_{symb}⁽⁰⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |
| 5 | 2 | x⁽⁰⁾(i) = d⁽⁰⁾(2i) | M_{symb}^{layer} = M_{symb}⁽⁰⁾/2 = |
| | | x⁽¹⁾(i) = d⁽⁰⁾(2i + 1) | M_{symb}⁽¹⁾/3 |
| | | x⁽²⁾(i) = d⁽¹⁾(3i) | |
| | | x⁽³⁾(i) = d⁽¹⁾(3i + 1) | |
| | | x⁽⁴⁾(i) = d⁽¹⁾(3i + 2) | |
| 6 | 2 | x⁽⁰⁾(i) = d⁽⁰⁾(3i) | M_{symb}^{layer} = M_{symb}⁽⁰⁾/3 = |
| | | x⁽¹⁾(i) = d⁽⁰⁾(3i + 1) | M_{symb}⁽¹⁾/3 |
| | | x⁽²⁾(i) = d⁽⁰⁾(3i + 2) | |
| | | x⁽³⁾(i) = d⁽¹⁾(3i) | |
| | | x⁽⁴⁾(i) = d⁽¹⁾(3i + 1) | |
| | | x⁽⁵⁾(i) = d⁽¹⁾(3i + 2) | |
| 7 | 2 | x⁽⁰⁾(i) = d⁽⁰⁾(3i) | M_{symb}^{layer} = M_{symb}⁽⁰⁾/3 = |
| | | x⁽¹⁾(i) = d⁽⁰⁾(3i + 1) | M_{symb}⁽¹⁾/4 |
| | | x⁽²⁾(i) = d⁽⁰⁾(3i + 2) | |
| | | x⁽³⁾(i) = d⁽¹⁾(4i) | |
| | | x⁽⁴⁾(i) = d⁽¹⁾(4i + 1) | |
| | | x⁽⁵⁾(i) = d⁽¹⁾(4i + 2) | |
| | | x⁽⁶⁾(i) = d⁽¹⁾(4i + 3) | |
| 8 | 2 | x⁽⁰⁾(i) = d⁽⁰⁾(4i) | M_{symb}^{layer} = M_{symb}⁽⁰⁾/4 = |
| | | x⁽¹⁾(i) = d⁽⁰⁾(4i + 1) | M_{symb}⁽¹⁾/4 |
| | | x⁽²⁾(i) = d⁽⁰⁾(4i + 2) | |
| | | x⁽³⁾(i) = d⁽⁰⁾(4i + 3) | |
| | | x⁽⁴⁾(i) = d⁽¹⁾(4i) | |
| | | x⁽⁵⁾(i) = d⁽¹⁾(4i + 1) | |
| | | x⁽⁶⁾(i) = d⁽¹⁾(4i + 2) | |
| | | x⁽⁷⁾(i) = d⁽¹⁾(4i + 3) | |

As shown in Table 1 above, for lower-rank communications (e.g., communications with fewer layers), DMRS signals may be transmitted using a single codeword. Comparatively, for higher-rank communications (e.g., communications with more layers), two codewords must be used among the layers. In particular, as shown in Table 1 above, one codeword may be used when the number of layers is less than four, and two codewords may be used when the number of layers for the respective communication (e.g., DMRS) is more than four, and less than or equal to eight.

Codeword-to-layer mapping may be performed in accordance with Table 1 above. Comparatively, in the context of layer-to-antenna port mapping, the block of vectors [x⁽⁰⁾(i) . . . x^{(v-1)}(i)]^{T}, i=0,1, . . . , M_{symb}^{layer}−1 may be mapped to antenna ports according to Equation 1 below:

$$[ \begin{matrix}{y}^{( {p}_{0} )} ( i ) \\ ⋮ \\ {y}^{( {p}_{υ - 1} )} ( i )\end{matrix} ] = [ \begin{matrix}{x}^{( 0 )} ( i ) \\ ⋮ \\ {x}^{( υ - 1 )} ( i )\end{matrix} ] \qquad ( 1 )$$

where i=0,1, . . . , M_{symb}^{ap}−1, M_{symb}^{ap}=M_{symb}^{layer}.

In some cases, antenna ports {p₀, . . . , pᵥ₋₁} which will be used for a respective communication (e.g., DMRS) may be determined according to the ordering of DMRS ports, which may be illustrated in Table 2 and Table 3 below:

TABLE 2
Antenna Port to DMRS Port Mapping (DMRS Type 1, Two Codewords)

| One Codeword: | | | | Two Codewords: | | | |
|---|---|---|---|---|---|---|---|
| Codeword 0 - Enabled | | | | Codeword 0 - Enabled | | | |
| Codeword 1 - Disabled | | | | Codeword 1 - Enabled | | | |
| | # of | | | | # of | | |
| | DMRS | | | | DMRS | | |
| Antenna | CDM | | # of | Antenna | CDM | | # of |
| Port | Group(s) | | Front- | Port | Group(s) | | Front- |
| Field | Without | DMRS | Loaded | Field | Without | DMRS | Loaded |
| Value | Data | Port(s) | Symbols | Value | Data | Port(s) | Symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | Reserved | Reserved | Reserved |
| 5 | 2 | 2 | 1 | | | | |

TABLE 3
Antenna Port to DMRS Port Mapping (DMRS Type 2, Two Codewords)

| One Codeword: | | | | Two Codewords: | | | |
|---|---|---|---|---|---|---|---|
| Codeword 0 - Enabled | | | | Codeword 0 - Enabled | | | |
| Codeword 1 - Disabled | | | | Codeword 1 - Enabled | | | |
| | # of | | | | # of | | |
| | DMRS | | | Value | DMRS | | |
| Antenna | CDM | | # of | Antenna | CDM | | # of |
| Port | Group(s) | | Front- | Port | Group(s) | | Front- |
| Field | Without | DMRS | Loaded | Field | Without | DMRS | Loaded |
| Value | Data | Port(s) | Symbols | Value | Data | Port(s) | Symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 4, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6-63 | Reserved | Reserved | Reserved |
| 7 | 2 | 0, 1 | 1 | | | | |

Table 2 above illustrates mappings between antenna ports and DMRS ports in the context of DMRS Type 1 for two codewords (e.g., Antenna port(s) (1000+MRS port), dmrs-Type-1, maxLength=2), whereas Table 3 above illustrates mappings between antenna ports and DMRS ports in the context of DMRS Type 2 for two codewords (e.g., Antenna port(s) (1000+5MRS port), dmrs-Type-2, maxLength=2).

DMRS port mapping configurations utilized by some wireless communications systems may be further shown and described via expanded tables. For example, DMRS port mapping configurations for DMRS Type 1 with two codewords may be further illustrated in Table 4 below:

TABLE 4
Antenna Port to DMRS Port Mapping (DMRS Type 1, Two Codewords)

| | # of | | | | |
|---|---|---|---|---|---|
| Antenna | DMRS CDM | | # of Layers/ | # of Layers/ | # of |
| Port | Group(s) | Total | DMRS port(s)/ | DMRS port(s)/ | front- |
| Field | Without | # of | CDM Group for | CDM Group for | loaded |
| Value | Data | Layers | Codeword 0 | Codeword 1 | symbols |
| 0 | 2 | 5 | 2/(0, 1)/(0, 0) | 3/(2, 3, 4)/(1, 1, 0) | 2 |
| 1 | 2 | 6 | 3/(0, 1, 2)/(0, 0, 1) | 3/(3, 4, 6)/(1, 0, 1) | 2 |
| 2 | 2 | 7 | 3/(0, 1, 2)/(0, 0, 1) | 4/(3, 4, 5, 6)/(1, 0, 0, 1) | 2 |
| 3 | 2 | 8 | 4/(0, 1, 2, 3)/(0, 0, 1, 1) | 4/(4, 5, 6, 7)/(0, 0, 1, 1) | 2 |
| 4-31 | Reserved | Reserved | Reserved | Reserved | Reserved |

As noted previously herein, for higher-rank communications (e.g., layers 5, 6, 7, 8), DMRSs may be transmitted in accordance with multiple codewords (e.g., Codeword 0, Codeword 1). For example, referring to Table 4 above, for antenna port field value=0, which corresponds to a DMRS with five total layers, two layers may be transmitted in accordance with Codeword 0, and three layers may be transmitted in accordance with Codeword 1. In the case of multiple TRP (mTRP) communications, DMRS associated with Codeword 0 may be transmitted via a first TRP, and DMRS associated with Codeword 1 may be transmitted via a second TRP. As will be described in further detail herein, in such cases, the respective TRPs may be spatially separated or co-located.

Each respective DMRS port may be mapped to a respective CDM group. For example, as shown in Table 4 above, DMRS ports 0, 1, 4, and 5 belong to CDM group 0, and DMRS ports 2, 3, 6, and 7 belong to CDM group 1. DMRS ports within a CDM group are orthogonalized via FD-OCC and TD-OCC, where DMRS ports in different CDM groups are independent of one another. For example, DMRS ports 0, 1, 4, and 5 corresponding to CDM group 0 may be orthogonal to one another via FD-OCC and TD-OCC.

Continuing with reference to Table 4, different mappings between antenna ports and DMRS ports are defined for each respective antenna port field value (e.g., antenna port-to-DMRS port mappings are different for antenna port field value=0 as compared to antenna port field value=1). Moreover, shown in Table 4 above, for all antenna port field values (e.g., all DMRS values), at least one codeword is composed of (e.g., includes) DMRS ports from both CDM groups 0 and 1. For example, for antenna port field value=0, Codeword 1 includes DMRS ports corresponding to both CDM groups 0 and 1. Similarly, for antenna port field value=1, both Codewords 1 and 2 include DMRS ports corresponding to both CDM groups 0 and 1.

Table 4 above illustrates DMRS port mapping configurations for DMRS Type 1 with two codewords. Comparatively, DMRS port mapping configurations for DMRS Type 2 with two codewords may be further illustrated with reference to Table 5 below:

TABLE 5
Antenna Port to DMRS Port Mapping (DMRS Type 2, Two Codewords)

| | # of | | | | |
|---|---|---|---|---|---|
| Antenna | DMRS CDM | | # of Layers/ | # of Layers/ | # of |
| Port | Group(s) | Total | DMRS port(s)/ | DMRS port(s)/ | front- |
| Field | Without | # of | CDM Group for | CDM Group for | loaded |
| Value | Data | Layers | Codeword 0 | Codeword 1 | symbols |
| 0 | 3 | 5 | 2/(0, 1)/(0, 0) | 3/(2, 3, 4)/(1, 1, 2) | 1 |
| 1 | 3 | 6 | 3/(0, 1, 2)/(0, 0, 1) | 3/(3, 4, 5)/(1, 2, 2) | 1 |
| 2 | 2 | 5 | 2/(0, 1)/(0, 0) | 3/(2, 3, 6)/(1, 1, 0) | 2 |
| 3 | 2 | 6 | 3/(0, 1, 2)/(0, 0, 1) | 4/(3, 6, 8)/(1, 0, 1) | 2 |
| 4 | 2 | 7 | 3/(0, 1, 2)/(0, 0, 1) | 4/(3, 6, 7, 8)/(1, 0, 0, 1) | 2 |
| 5 | 2 | 8 | 4/(0, 1, 2, 3)/(0, 0, 1, 1) | 4/(6, 7, 8, 9)/(0, 0, 1, 1) | 2 |
| 6-63 | Reserved | Reserved | Reserved | Reserved | Reserved |

Once again, each respective DMRS port may be mapped to a respective CDM group. For example, as shown in Table 5 above, DMRS ports 0, 1, 6, and 7 belong to CDM group 0, DMRS ports 2, 3, 8, and 9 belong to CDM group 1, and DMRS ports 4, 5, 10, and 11 belong to CDM group 2. DMRS ports within a CDM group are orthogonalized via FD-OCC and TD-OCC, where DMRS ports in different CDM groups are independent of one another. By comparing Tables 4 and 5, it may be seen that the mappings between DMRS ports and CDM groups is different between DMRS Type 1 and DMRS Type 2.

As shown in Table 5 above, for all antenna port field values (e.g., DMRS values), at least one codeword is composed of (e.g., includes) DMRS ports from two or more of the three potential CDM groups. For example, referring to Table 5, for antenna port field value=1 (six-layer communication), Codeword 0 is associated with DMRS ports 0, 1, and 2, which correspond to CDM group 0, CDM group 0, and CDM group 1, respectively. Moreover, Codeword 1 is associated with DMRS ports 3, 4, and 5, which correspond to CDM group 1, CDM group 2, and CDM group 2, respectively. In this regard, for antenna port field value=1 (e.g., DMRS value 1), DMRS groups for all three CDM groups (e.g., CDM groups 0, 1, 2) are used between the two codewords. The same may be said for antenna port field value=0 (e.g., DMRS value 0).

The DMRS port mapping configurations illustrated in Tables 4 and 5 above demonstrate two fundamental shortcomings for conventional DMRS port mapping configurations used by some wireless communications systems. First, in the context of DMRS port mapping for two codewords (e.g., Codeword 0, Codeword 1), current DMRS port mapping configurations preclude distributed encoding of the codewords per transport block at each TRP of an mTRP transmitting device. Moreover, the current DMRS port mapping configurations illustrated in Tables 4 and 5 above render channel estimates for the two respective TRPs inseparable, and therefore unresolvable at the receiving device. In other words, using conventional DMRS port mapping configurations, a receiving device would not be able to separate the first codeword transmitted by a first TRP from the second codeword transmitted by a second TRP, and would therefore be unable to perform channel estimates for each of the respective TRPs. Moreover, signals from the respective TRPs may have different timing offsets and different channel conditions, which may be unable to be measured/determined according to current DMRS port mapping configurations for two codewords.

In particular, for DMRS port mapping tables (as shown in Tables 4 and 5 above), channel estimates for DMRS ports belonging to the same CDM group will exhibit the impact of channel conditions from both TRPs, and are therefore not separable due to the fact that the DMRS ports belonging to the same CDM group are assigned to both codewords. In other words, for communications with more than four layers, mTRP communications do not support space-division multiplexing (SDM) with the existing DMRS port mapping tables for DMRS Type 1 and DMRS Type 2.

For example, referring to Table 5 above, an mTRP transmitting device (e.g., base station 105) communicating in accordance with antenna port field value=1 may transmit a first DMRS for Codeword 0 from a first TRP, and may transmit a second DMRS for Codeword 1 from a second TRP. As shown in Table 5, for antenna port field value=1, the first DMRS for Codeword 0 may include DMRS port 2 corresponding to CDM group 1. Moreover, the second DMRS for Codeword 1 may include DMRS port 3 corresponding to CDM group 1. In this regard, at a receiving device (e.g., UE 115), the channel estimates for DMRS ports belonging to CDM group 1 (e.g., DMRS ports 2 and 3) may exhibit the impact of channel conditions from both the first and second TRPs. As such, the channel estimates for both TRPs may not be separable at the receiving device due to the fact that both Codeword 0 and Codeword 1 include DMRS ports corresponding to CDM group 1. Thus, using the current DMRS port mapping configuration illustrated in Table 5, the receiving device may be unable to perform channel estimates for channels between the receiving device and the respective TRPs at the mTRP transmitting device.

By way of another example, referring to Table 4 for DMRS Type 1 with two codewords and for antenna port field value=0, channel estimates for DMRS ports 0 and 1 for Codeword 0 and DMRS port 4 of Codeword 1 will be unresolvable across the two TRPs of the transmitting device. Comparatively, antenna port field value=0 in Table 5 for DMRS Type 2 with two codewords does not exhibit this shortcoming. That is, for antenna port field value=0 in Table 5, DMRS ports for each CDM group are only associated with a single codeword, and there are not any CDM groups which include DMRS ports for both codewords.

However, channel estimates for the respective codewords may be inseparable, and therefore unresolvable, for the remaining antenna port field values in Table 5. For instance, for antenna port field value=1 in Table 5, channel estimates for DMRS ports 0, 1, and 2 of Codeword 0 and DMRS ports 3 and 6 for Codeword 1 will be unresolvable for the two TRPs. Moreover, for antenna port field value=2 in Table 5, channel estimates for DMRS ports 0 and 1 of Codeword 0 and DMRS port 6 for Codeword 1 will be unresolvable for the two TRPs. Further, for antenna port field values=3 through 5, channel estimates for all DMRS ports are unresolvable for the two TRPs.

Current DMRS port mapping configurations also exhibit shortcomings in the context of single TRP communications. For the single TRP single user case, estimating the channel corresponding to each codeword may require estimating the channel corresponding to the DMRS ports of more than one CDM group. In other words, current DMRS port mapping configurations require receiving devices to perform channel estimation for DMRS ports corresponding to multiple CDM groups in order to perform channel estimation for each respective codeword. This may lead to relatively higher computational complexity for receiving devices.

Accordingly, aspects of the present disclosure are directed to new DMRS port mapping configurations which resolve shortcomings present within existing DMRS port mapping configurations. In particular, aspects of the present disclosure are directed to new antenna port-to-DMRS port mapping configurations (e.g., DMRS port mapping configurations) which enable DMRS ports belonging to the same CDM groups to be assigned to the same codeword. Such techniques may prevent DMRS ports for the same CDM group from being distributed across multiple codewords, as is the case with legacy codeword-to-DMRS port mapping schemes. As such, techniques described herein may enable mTRP communications in the context of two codewords.

Some aspects of the present disclosure are further directed to UE capability signaling which may be used by UEs 115 to indicate a capability (or lack thereof) to support communications performed in accordance with DMRS port mapping configurations described herein. In such cases, new antenna port-to-DMRS port mapping configurations (e.g., DMRS port mapping configurations) may be applied or implemented only in cases in which UEs 115 indicate a capability to support such DMRS port mapping configurations.

For example, as shown in FIG. 2, the UE 115 may transmit capability signaling 210, where the capability signaling 210 indicates a capability of the UE 115 to communicate in accordance with DMRS port mapping configurations of the present disclosure. In this regard, the capability signaling 210 may indicate a capability of the UE 115 to communicate in accordance with DMRS port mapping configurations which include/define mappings between codewords (e.g., Codeword 0, Codeword 1) and DMRS ports associated with respective CDM groups. In particular, the capability signaling 210 may indicate a capability of the UE 115 to support DMRS port mapping configurations which enable DMRS ports belonging to the same CDM groups to be assigned to the same codeword are further shown and described with reference to Tables 6 and 7 below:

TABLE 6
Antenna Port to DMRS Port Mapping for DMRS Type 1 for Two Codewords

| | # of | | | | |
|---|---|---|---|---|---|
| Antenna | DMRS CDM | | # of Layers/ | # of Layers/ | # of |
| Port | Group(s) | Total | DMRS port(s)/ | DMRS port(s)/ | front- |
| Field | Without | # of | CDM Group for | CDM Group for | loaded |
| Value | Data | Layers | Codeword 0 | Codeword 1 | symbols |
| 0 | 2 | 5 | 2/(0, 1)/(2, 3)/(1, 1) | 3/(2, 3, 4)/(0, 1, 4)/(0, 0, 0) | 2 |
| 1 | 2 | 6 | 3/(0, 1, 2)/(0, 1, 4)/(0, 0, 0) | 3/(3, 4, 5)/(2, 3, 6)/(1, 1, 1) | 2 |
| 2 | 2 | 7 | 3/(0, 1, 2)/(2, 3, 6)/(1, 1, 1) | 4/(3, 4, 5, 6)/(0, 1, 4, 5)/ | 2 |
| | | | | (0, 0, 0, 0) | |
| 3 | 2 | 8 | 4/(0, 1, 2, 3)/(0, 1, 4, 5)/ | 4/(4, 5, 6, 7)/(2, 3, 6, 7)/ | 2 |
| | | | (0, 0, 0, 0) | (1, 1, 1, 1) | |
| 4-31 | Reserved | Reserved | Reserved | Reserved | Reserved |

TABLE 7
Antenna Port to DMRS Port Mapping for DMRS Type 2 for Two Codewords

| | # of | | | | |
|---|---|---|---|---|---|
| | DMRS | | | | |
| Antenna | CDM | | # of Layers/ | # of Layers/ | # of |
| Port | Group(s) | Total | DMRS port(s)/ | DMRS port(s)/ | front- |
| Field | Without | # of | CDM Group for | CDM Group for | loaded |
| Value | Data | Layers | Codeword 0 | Codeword 1 | symbols |
| 0 | 3 | 5 | 2/(0, 1)/(0, 1)/(0, 0) | 3/(2, 3, 4)/(2, 3, 4)/(1, 1, 2) | 1 |
| [symbol] | [symbol] | [symbol] | [symbol] | [symbol] | [symbol] |
| 2 | 2 | 5 | 2/(0, 1)/(2, 3)/(1, 1) | 3/(2, 3, 4)/(0, 1, 6)/(0, 0, 0) | 2 |
| 3 | 2 | 6 | 3/(0, 1, 2)/(0, 1, 6)/(0, 0, 0) | 4/(3, 4, 5)/(2, 3, 8)/(1, 1, 1) | 2 |
| 4 | 2 | 7 | 3/(0, 1, 2)/(2, 3, 8)/(1, 1, 1) | 4/(3, 4, 5, 6)/(0, 1, 6, 7)/(0, 0, 0, 0) | 2 |
| 5 | 2 | 8 | 4/(0, 1, 2, 3)/(0, 1, 6, 7)/(0, 0, 0, 0) | 4/(4, 5, 6, 7)/(2, 3, 6, 7)/(1, 1, 1, 1) | 2 |
| 6-63 | Reserved | Reserved | Reserved | Reserved | Reserved |

The UE 115 and the base station 105 of the wireless communications system 200 may be configured to communicate in accordance with the DMRS port mapping configurations illustrated in Tables 6 and 7 above. Table 6 above illustrates an example DMRS port mapping configuration of the present disclosure for DMRS Type 1 for two codewords, where Table 7 above illustrates an example DMRS port mapping configuration of the present disclosure for DMRS Type 2 for two codewords. In some aspects, Tables 6 and 7 may be reflected in new DMRS port mapping tables which may be added in addition to the legacy DMRS port mapping tables reflected in Tables 4 and 5 above. Additionally, or alternatively, the DMRS port mapping configurations illustrated in Tables 6 and 7 may be implemented using unused/reserved antenna port field values in Tables 4 and 5 above.

As shown in Tables 6 and 7 above, DMRS port mapping configurations described herein may be implemented such that DMRS ports belonging to the same CDM groups to be assigned to the same codeword. As such, DMRS port mapping configurations described herein may enable mTRP communications associated with multiple codewords to be separable at the receiving device, which may facilitate mTRP channel estimation at the receiving device.

For example, referring to antenna port field value=0 in Table 6, a transmitting device may transmit a first DMRS for Codeword 0 via a first TRP, and may transmit a second DMRS for Codeword 1 via a second TRP. As shown in Table 6, the first DMRS for Codeword 0 may include DMRS ports 2 and 3, which both correspond to CDM group 1. Similarly, the second DMRS signal for Codeword 1 may include DMRS ports 0, 1, and 4, which all correspond to CDM group 0. As such, there are no CDM groups which include DMRS ports associated with both codewords, meaning that the respective DMRS signals corresponding to the respective codewords and TRPs are separable at the receiving device, thereby enabling the receiving device to perform channel estimation for the respective TRPs.

Similarly, continuing with reference to the DMRS port mapping configuration illustrated in Table 6, the DMRS port mapping configuration may include or define, for each respective antenna port field value, a first mapping for Codeword 0 and a second mapping for Codeword 1, where the mappings ensure that DMRS ports corresponding to each CDM group are only associated with one of the codewords. For example, for antenna port field value=1 in Table 6, Codeword 0 is only associated with DMRS ports which correspond to CDM group 0, and Codeword 1 is only associated with DMRS ports which correspond to CDM group 1. Similarly, for antenna port field value=2 in Table 6, Codeword 0 is only associated with DMRS ports which correspond to CDM group 1, and Codeword 1 is only associated with DMRS ports which correspond to CDM group 0. Moreover, for antenna port field value=3 in Table 6, Codeword 0 is only associated with DMRS ports which correspond to CDM group 0, and Codeword 1 is only associated with DMRS ports which correspond to CDM group 1.

Similarly, with the exception of antenna port field value=1 in Table 7, the DMRS port mapping configuration illustrated in Table 7 for DMRS Type 2, the DMRS port mapping configuration may include or define, for each respective antenna port field value, a first mapping for Codeword 0 and a second mapping for Codeword 1, where the mappings ensure that DMRS ports corresponding to each CDM group are only associated with one of the codewords. In other words, with the exception of antenna port field value=1 in Table 7, the DMRS port mapping configuration includes/defines mappings such that there are not any CDM groups which include DMRS ports for both Codeword 0 and Codeword 1. For example, for antenna port field value=0 in Table 7, Codeword 0 includes DMRS ports 0 and 1 corresponding to CDM group 0, and Codeword 1 includes DMRS ports 2, 3, and 4 corresponding to CDM groups 1 and 2. As such, for antenna port field value=0, the DMRS port mapping configuration includes/defines mappings for each respective codeword such that DMRS ports corresponding to each CDM group are only associated with one of the codewords (e.g., none of the CDM groups include DMRS ports for both Codeword 0 and Codeword 1). In some aspects, for DMRS Type 2 with two codewords, aspects of the present disclosure may support two front-loaded DMRS cases with two CDM groups without data for communications with more than four layers.

Continuing with reference to Table 7, antenna port field value=1 for DMRS Type 2 is not feasible, in that the mappings result in DMRS ports for a single CDM group being associated with both codewords (e.g., CDM group includes DMRS ports 2 and 3, which are associated with Codeword 0 and Codeword 1, respectively). In particular, for antenna port field value=1 in Table 7, CDM group 1 includes DMRS ports for both Codeword 0 (DMRS port 2) and Codeword 1 (DMRS port 3), making channel estimation for CDM group across the respective codewords inseparable, and therefore infeasible for mTRP use cases. As such, in some implementations, the use of antenna port field value=1 in Table 7 above may be precluded from being used in RRC configuration, which may reduce processing complexity and improve channel estimation. That is, the UE 115 and the base station 105 of the wireless communications system 200 may be precluded from performing communications in accordance with antenna port field value=1 in Table 7 in the context of mTRP communications.

In some implementations, the capability signaling 210 may indicate that the UE 115 is capable of performing communications in accordance with the DMRS port mapping configurations described herein within particular frequency bands (e.g., BWPs), component carriers, cells, and the like. In other words, DMRS port mapping configurations may be supported at the UE 115 for individual BWPs, component carriers, cells, and the like (e.g., capability per-band, per-BWP, per-component carrier). In this regard, the capability signaling 210 may indicate one or more frequency bands, component carriers, or both, which are associated with the capability of the UE 115 to communicate in accordance with the DMRS port mapping configurations, as shown in Tables 6 and 7, for example.

In some aspects, the UE 115 may receive, from the base station 105, first control signaling 215-a that indicates a DMRS port mapping configuration. For example, the first control signaling 215-a may indicate a DMRS port mapping configuration illustrated in Table 6 and/or Table 7 above. The first control signaling 215-a may include an RRC message, a MAC-CE message, or both. In some aspects, the UE 115 may receive the first control signaling 215-a based on (e.g., in response to) transmitting the capability signaling 210 indicating the capability of the UE 115 to communicate in accordance with the DMRS port mapping configuration. For example, in some cases, the first control signaling 215-a may confirm and/or activate the DMRS port mapping configuration in response to the capability signaling 210

In some aspects, DMRS port mapping configurations described herein may be reflected in new DMRS port mapping tables. In such cases, legacy DMRS port mapping configurations may be reflected in legacy DMRS port mapping tables (e.g., Tables 4 and 5), where new DMRS port mapping configurations may be reflected in new DMRS port mapping tables (e.g., Tables 6 and 7). Additionally, or alternatively, unused/reserved antenna port field values in existing DMRS port mapping tables (e.g., antenna port field values=4 through 31 in Table 4, antenna port field values=6 through 63 in Table 5) may be re-purposed to implement new DMRS port mapping configurations described herein. In such cases, legacy DMRS port mapping tables (e.g., Tables 4 and 5) may be extended/modified to reflect both legacy DMRS port mapping configurations, and new DMRS port mapping configurations described herein. That is, the DMRS port mapping configurations illustrated in Tables 6 and 7 may be implemented by re-purposing antenna port field values=4 through 31 in Table 4 and antenna port field values=6 through 63 in Table 5.

In some aspects, in the context of mTRP communications, DMRS port mapping configurations for two codewords may be feasible. In other words, DMRS port mapping configurations described herein may enable channel estimates for each TRP to become separable at the receiver, since each codeword includes DMRS ports from different CDM groups. As such, techniques described herein may support SDM for mTRP communications. Moreover, DMRS port mapping configurations described herein may enable distributed encoding of each codeword per transport block at the mTRP transmitter, which may enable a reduction in computational complexity at the transmitter. Further, because receivers only need to compute channel estimates for DMRS ports of the involved CDM group for each respective codeword, DMRS port mapping configurations described herein may enable reduced complexity receiver designs.

Subsequently, the UE 115 may receive, from the base station 105, second control signaling 215-b that indicates an antenna port field value included within the set of antenna port field values associated with the DMRS port mapping configuration. For example, in cases where the first control signaling 215-a configures the DMRS port mapping configuration illustrated in Table 6, the second control signaling 215-b may indicate one of the antenna port field values 0 through 3 which will be used for DMRSs exchanged between the UE 115 and the base station 105. In some aspects, the second control signaling 215-b may include a DCI message, a MAC-CE message, or both. The UE 115 may receive the second control signaling 215-b at 525 based on transmitting the capability signaling 210 at 515, receiving the first control signaling 215-a at 520, or both.

In some aspects, the first control signaling 215-a, the second control signaling 215-b, or both, may schedule one or more DMRS transmissions which are to be performed in accordance with the indicated DMRS port mapping configuration and/or antenna port field value. For example, the second control signaling 215-b (e.g., DCI message) may indicate a set of resources which will be used to perform (e.g., transmit, receive) one or more DMRS transmissions (e.g., first DMRS 220-a, second DMRS 220-b). In this example, one or more DMRSs 220 scheduled by the second control signaling 215-b may be performed in accordance with the DMRS port mapping configuration indicated via the first control signaling 215-a, and the antenna port field value indicated via the second control signaling 215-b.

In cases where the UE 115 is configured with multiple candidate DMRS port mapping tables (e.g., legacy DMRS port mapping tables and new DMRS port mapping tables), the second control signaling 215-b may additionally indicate which DMRS port mapping table is to be used. For example, the UE 115 may be configured with legacy port mapping tables shown in Tables 4 and 5, and new port mapping tables shown in Tables 6 and 7. In such cases, the second control singling may indicate which port mapping table is to be used, as well as the applicable antenna port field value within the respective table.

In some aspects, the UE 115, the base station 105, or both, may reference one or more port mapping tables associated with the indicated DMR port mapping configuration in order to identify DMRS ports which will be used to transmit/receive scheduled DMRS transmissions. The UE 115 and the base station 105 may reference the port mapping table(s) based on the first control signaling 215-a, the second control signaling 215-b, or both. In particular, the UE 115 and/or the base station 105 may reference one or more port mapping tables associated with the indicated DMRS port mapping configuration based on the antenna port field value indicated via the second control signaling 215-b. For example, the second control singling may indicate that the DMRS port mapping configuration corresponds to Table 7 above, and may further indicate antenna port field value=2. In this example, the UE 115 and the base station 105 may reference Table 7 by indexing the table according to antenna port field value=2.

The UE 115, the base station 105, or both, may identify one or more DMRS ports which will be used to perform (e.g., transmit, receive) the scheduled DMRS transmission(s). For example, in cases where the base station 105 schedules a first DMRS 220-a and a second DMRS 220-b, the UE 115 and the base station 105 may identify a first set of DMRS ports associated with the first DMRS 220-a, and a second set of DMRS ports associated with the second DMRS 220-b. In some aspects, the UE 115 and the base station 105 may identify the DMRS port(s) which are to be used based on transmitting/receiving the capability signaling 210, transmitting/receiving the first control signaling 215-a, transmitting/receiving the second control signaling 215-b, referencing the port mapping table(s) at 530, or any combination thereof.

In some aspects, the UE 115 may receive a first DMRS 220-a from the base station 105. Similarly, the UE 115 may receive a second DMRS 220-b from the base station 105. The UE 115 may receive, and the base station 105 may transmit, the first DMRS 220-a and the second DMRS 220-b based on transmitting/receiving the capability signaling 210, transmitting/receiving the first control signaling 215-a, transmitting/receiving the second control signaling 215-b, referencing the port mapping table(s), identifying the DMRS port(s) which are to be used to transmit/receive the DMRSs 220, or any combination thereof. For example, the UE 115 may receive, and the base station 105 may transmit, the first DMRS 220-a and the second DMRS 220-b in accordance with the DMRS port mapping configuration (e.g., in accordance with the mappings defined by the DMRS port mapping configuration) and the indicated antenna port field value.

In some aspects, the first DMRS 220-a and second DMRS 220-b may be associated with (e.g., include) different codewords. For example, in some cases, the first DMRS 220-a may be associated with/include Codeword 0, and the second DMRS 220-b may be associated with/include Codeword 1. The first DMRS 220-a and second DMRS 220-b may be transmitted/received based on (e.g., in accordance with) the identified DMRS ports. Moreover, in some implementations, the first DMRS 220-a may be transmitted via a first TRP at the base station 105, where the second DMRS 220-b may be transmitted via a second TRP at the base station 105. In such cases, the first and second TRPs may be spatially separated at the base station 105. Additionally, or alternatively, the first and second TRPs may be co-located at the base station 105.

For example, continuing with the example above, the second control singling may indicate that the DMRS port mapping configuration corresponds to Table 7 above, and may further indicate antenna port field value=2. In this example, the UE 115 may receive the first DMRS 220-a including Codeword 0 using DMRS ports 2 and 3 corresponding to CDM group 1 in accordance with a first mapping for Codeword 0 defined by the DMRS port mapping configuration. Similarly, the UE 115 may receive the second DMRS 220-b including Codeword 1 using DMRS ports 0, 1, and 6 corresponding to CDM group 0 in accordance with a second mapping for Codeword 1 defined by the DMRS port mapping configuration. In this example, the first DMRS 220-a including Codeword 0 may be transmitted by via the first TRP at the base station 105, and the second DMRS 220-b including Codeword 1 may be transmitted by via the second TRP at the base station 105. Moreover, in this example, the first DMRS 220-a may be associated with (e.g., include) to layers, where the second DMRS 220-b may be associated with three layers, as shown in Table 7.

By way of another example, the second control singling may indicate that the DMRS port mapping configuration corresponds to Table 7 above, and may further indicate antenna port field value=0. In this example, the UE 115 may receive the first DMRS 220-a including Codeword 0 using DMRS ports 0 and 1 corresponding to CDM group 0 in accordance with a first mapping for Codeword 0 defined by the DMRS port mapping configuration. Similarly, the UE 115 may receive the second DMRS 220-b including Codeword 1 using DMRS ports 2 and 3 corresponding to CDM group 1 in accordance with a second mapping for Codeword 1 defined by the DMRS port mapping configuration. Further, the UE 115 may receive the second DMRS 220-b including Codeword 1 using DMRS port 4 corresponding to CDM group 2 in accordance with a third mapping for Codeword 1 defined by the DMRS port mapping configuration. In this example, the first DMRS 220-a including Codeword 0 may be transmitted by via the first TRP at the base station 105, and the second DMRS 220-b including Codeword 1 may be transmitted by via the second TRP at the base station 105. Moreover, in this example, the first DMRS 220-a may be associated with (e.g., include) to layers, where the second DMRS 220-b may be associated with three layers, as shown in Table 7.

In some aspects, the UE 115 may receive (and the base station 105 may transmit) the first DMRS 220-a and the second DMRS 220-b within sets of resources indicated via the second control signaling 215-b. For example, the second control signaling 215-b (e.g., DCI message) may indicate one or more sets of resources which will be used to transmit/receive the first DMRS 220-a and the second DMRS 220-b. Further, in cases where the capability signaling 210 indicates frequency bands and/or component carriers in which the UE 115 supports communications in accordance with the DMRS port mapping configuration, the DMRSs 220 may be transmitted/received within the indicated frequency bands/component carriers.

In some aspects, the UE 115 may perform channel estimation procedures based on the received DMRSs 220. For example, in cases where the first DMRS 220-a and the second DMRS 220-b are transmitted via first and second TRPs at the base station 105, respectively, the UE 115 may determine a first channel estimate associated with a first channel between the UE 115 and the first TRP based on the first codeword (and corresponding CDM groups) of the first DMRS 220-a, and may determine a second channel estimate associated with a second channel between the UE 115 and the second TRP based on the second codeword (and corresponding CDM groups) of the second DMRS 220. As noted previously herein, the DMRS port mapping configurations described herein may ensure that DMRS ports corresponding to each respective CDM group correspond to a single codeword, thereby enabling the separate DMRSs/codewords to be separable at the ULE 115 to enable channel estimation.

In some implementations, the UE 115 may determine the channel estimates for the respective channels/TRPs/DMRSs based on TRSs or CSI-RSs for the respective TRPs. TRSs may be used to determine parameters associated with the channels for the respective TRPs, such as doppler spread/shift, average delay, delay spread, modulation (e.g., MCS), and the like. For example, in cases where the first DMRS 220-a and second DMRS 220-b are transmitted via first and second TRPs at the base station 105, respectively, the UE 115 may determine a first channel estimate associated with the first TRP based on a first TRS/CSI-RS associated with the first TRP, and may determine a second channel estimate associated with and the second TRP based on a second TRS/CSI-RS associated with the second TRP. In cases where the first and second TRPs are co-located at the base station 105, the UE 115 may determine the respective channel estimates based on a single TRS associated with the co-located TRPs.

In some implementations, DMRS port mapping configurations described herein may also be compatible with wireless communications systems which support increased quantities of orthogonal DMRS ports. In particular, the UE 115 and the base station 105 of the wireless communications system 200 may support techniques which enable higher quantities of orthogonal DMRS ports for wireless communications, where the DMRS port mapping configurations may be implemented for the increased quantities of orthogonal DMRS ports. The wireless communications system 200 may enable techniques for increasing a sequence length of FD-OCCs supported by the wireless communications system, thereby increasing a quantity of available orthogonal DMRS ports for supporting a higher number of spatial layers for uplink transmissions. In particular, the wireless communications system 100 may support techniques for signaling higher-order FD-OCCs (e.g., having a sequence length N>2), and configurations for indicating antenna port values for higher-quantities of supported DMRS ports.

For example, a UE 115 of the wireless communications system 100 may receive control signaling (e.g., RRC signaling, MAC-CE signaling, DCI signaling) which indicates an FD-OCC sequence length value for wireless communications with the network. The FD-OCC sequence length value may be 4, 6, 8, etc. (e.g., N=4, 6, 8). The UE may then receive an indication of an antenna port field value, and may determine which one or more orthogonal DMRS ports are to be used for transmitting DMRSs based on the indicated FD-OCC sequence length value and the antenna port value. In some aspects, the UE 115 may be configured to identify a set of cyclic shift (CS) sequence values, a Walsh sequence, or both, based on the indicated antenna port field value and the indicated sequence length value, and may determine one or more DMRS ports at the UE 115 which are to be used based on the identified CS values and/or Walsh sequence. In some aspects, a quantity of CS values within the set of CS sequence values and/or the length of the Walsh sequence may be based on the sequence length.

An example DMRS port mapping configuration for DMRS Type 1 and a CS sequence length of four (N=4, or 4CS) is illustrated in Table 8 below:

TABLE 8
DMRS Port Mappings (N = 4, DMRS Type 1) -
2 DMRS symbols (maxLength = 2)

| | | | | wₜ |
|---|---|---|---|---|
| | CDM | | | I′ = 0, |
| Port | Group | α(p) | w_{f}(α, k′) | I′ = 1 |
| 1000 | 0 | 0 | [1 1 1 1] | [1 1] |
| 1001 | 0 | π | [1 −1 1 −1] | [1 1] |
| 1002 | 1 | 0 | [1 1 1 1] | [1 1] |
| 1003 | 1 | π | [1 −1 1 −1] | [1 1] |
| 1004 | 0 | 0 | [1 1 1 1] | [1 −1] |
| 1005 | 0 | π | [1 −1 1 −1] | [1 −1] |
| 1006 | 1 | 0 | [1 1 1 1] | [1 −1] |
| 1007 | 1 | π | [1 −1 1 −1] | [1 −1] |
| 1008 | 0 | π/2 | [1 +j −1 −j] | [1 1] |
| 1009 | 0 | 3π/2 | [1 −j −1 +j] | [1 1] |
| 1010 | 1 | π/2 | [1 +j −1 −j] | [1 1] |
| 1011 | 1 | 3π/2 | [1 −j −1 +j] | [1 1] |
| 1012 | 0 | π/2 | [1 +j −1 −j] | [1 −1] |
| 1013 | 0 | 3π/2 | [1 −j −1 +j] | [1 −1] |
| 1014 | 1 | π/2 | [1 +j −1 −j] | [1 −1] |
| 1015 | 1 | 3π/2 | [1 −j −1 +j] | [1 −1] |

where the value of α is used to determine which CS values (e.g., 0, π/2, π, 3π/2) will be used, and where the orthogonal sequence corresponds to the following Walsh sequences

$$\begin{matrix}{α}_{i} ( 0 ) = [ \begin{matrix}+ 1 & + 1 & + 1 & + 1\end{matrix} ] \\ {α}_{i} ( 1 ) = [ \begin{matrix}+ 1 & - 1 & + 1 & - 1\end{matrix} ] \\ {α}_{i} ( 2 ) = [ \begin{matrix}+ 1 & + 1 & - 1 & - 1\end{matrix} ] \\ {α}_{i} = [ \begin{matrix}+ 1 & - 1 & - 1 & + 1\end{matrix} ]\end{matrix}$$

and/or the following CS values:

$$\begin{matrix}{α}_{i} = 0 ⟶ [ \begin{matrix}+ 1 & + 1 & + 1 & + 1\end{matrix} ] \\ {α}_{i} = π ⟶ [ \begin{matrix}+ 1 & - 1 & + 1 & - 1\end{matrix} ] \\ {α}_{i} = π / 2 ⟶ [ \begin{matrix}+ 1 & + j & - 1 & - j\end{matrix} ] \\ {α}_{i} = 3 π / 2 ⟶ [ \begin{matrix}+ 1 & - j & - 1 & + j\end{matrix} ]\end{matrix}$$

In Table 8 above, the DMRS ports 1000-1003 and 1008-1011 include ports for a single symbol. Moreover, as shown in Table 8 above, antenna ports 1000, 1001, 1004, 1005, 1008, 1009, 1012, and 1013 (corresponding to DMRS ports 0, 1, 4, 5, 8, 9, 12, and 13) are associated with CDM group 0, where antenna ports 1002, 1003, 1006, 1007, 1010, 1011, 1014, and 1015 (corresponding to DMRS ports 2, 3, 6, 7, 10, 11, 14, and 15) are associated with CDM group 1.

DMRS port mapping configurations for increased quantities of orthogonal DMRS ports in the context of DMRS Type 1 and maxLength=1 are further shown in Tables 9 and 10 below:

TABLE 9
DMRS Port Mapping (DMRS Type 1, maxLength = 1)
One Codeword:
Codeword 0 - Enabled
Codeword 1 - Disabled

| | # of DMRS | |
|---|---|---|
| Antenna Port | CDM Group(s) | DMRS |
| Field Value | Without Data | Port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

TABLE 10
DMRS Port Mapping for Increased Numbers
of Ports (DMRS Type 1, maxLength = 1)

| One Codeword: | | | Two Codewords: | | |
|---|---|---|---|---|---|
| Codeword 0 - Enabled | | | Codeword 0 - Enabled | | |
| Codeword 1 - Disabled | | | Codeword 1 - Enabled | | |
| | # of | | | # of | |
| | DMRS | | | DMRS | |
| Antenna | CDM | | Antenna | CDM | |
| Port | Group(s) | | Port | Group(s) | |
| Field | Without | DMRS | Field | Without | DMRS |
| Value | Data | Port(s) | Value | Data | Port(s) |
| 0 | 1 | 0, 8 | 4 | 2 | (0, 1, 2, 8, 10) |
| 1 | 1 | 1, 9 | 5 | 2 | (0, 1, 2, 3, 8, 10) |
| 2 | 1 | (0, 1), (8, 9) | 6 | 2 | (0, 1, 2, 3, 8, 9, 10) |
| 3 | 2 | 0, 8 | 7 | 2 | (0-3, 8-11) |
| 4 | 2 | 1, 9 | 0-3, 8-15 | Reserved | Reserved |
| 5 | 2 | 2, 10 | | | |
| 6 | 2 | 3, 11 | | | |
| 7 | 2 | (0, 1), (8, 9) | | | |
| 8 | 2 | (2, 3), | | | |
| | | (10, 11) | | | |
| 9 | 2 | (0-2), | | | |
| | | (8-10) | | | |
| 10 | 2 | (0-3), | | | |
| | | (8-11) | | | |
| 11 | 2 | (0, 2), (8, 10) | | | |
| 12 | 1 | (0, 1, 8) | | | |
| 13 | 1 | (0, 1, 8, 9) | | | |
| 14-15 | Reserved | Reserved | | | |

As shown in Tables 9 and 10 above, Table 9 is configured for one codeword and four or less ports (maxLength=l). Comparatively, Table 10 is configured for maxLength=1 where up to eight ports may be used. Specifically, Table 10 includes two sets of columns: a first set of columns when a UE 115 is scheduled with a single codeword (e.g., four or less ports), and a second set of columns when the UE 115 is scheduled with two codewords (e.g., more than four ports).

Comparatively, DMRS port mapping configurations for increased quantities of orthogonal DMRS ports in the context of DMRS Type 1 and maxLength=2 are further shown in Tables 11 and 12 below:

TABLE 11
DMRS Port Mapping (DMRS Type 1, maxLength = 2)

| One Codeword: | | | | Two Codewords: | | | |
|---|---|---|---|---|---|---|---|
| Codeword 0 - Enabled | | | | Codeword 0 - Enabled | | | |
| Codeword 1 - Disabled | | | | Codeword 1 - Enabled | | | |
| | # of | | | | # of | | |
| | DMRS | | | | DMRS | | |
| Antenna | CDM | | # of | Antenna | CDM | | # of |
| Port | Group(s) | | Front- | Port | Group(s) | | Front- |
| Field | Without | DMRS | Loaded | Field | Without | DMRS | Loaded |
| Value | Data | Port(s) | Symbols | Value | Data | Port(s) | Symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | Reserved | Reserved | Reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

TABLE 12
DMRS Port Mapping for Increased Numbers of Ports (DMRS Type 1, maxLength = 2)

| One Codeword: | | | | Two Codewords: | | | |
|---|---|---|---|---|---|---|---|
| Codeword 0 - Enabled | | | | Codeword 0 - Enabled | | | |
| Codeword 1 - Disabled | | | | Codeword 1 - Enabled | | | |
| | # of | | | | # of | | |
| | DMRS | | | | DMRS | | |
| Antenna | CDM | | # of | Antenna | CDM | | # of |
| Port | Group(s) | | Front- | Port | Group(s) | | Front- |
| Field | Without | DMRS | Loaded | Field | Without | DMRS | Loaded |
| Value | Data | Port(s) | Symbols | Value | Data | Port(s) | Symbols |
| 0 | 1 | 0, 8 | 1 | 0 | 2 | (0-4) | 2 |
| 1 | 1 | 1, 9 | 1 | 1 | 2 | (0, 1, 2, 3, 4, 6) | 2 |
| 2 | 1 | (0, 1), (8, 9) | 1 | 2 | 2 | (0, 1, 2, 3, 4, 5, 6) | 2 |
| 3 | 2 | 0, 8 | 1 | 3 | 2 | (0, 1, 2, 3, 4, 5, 6, 7) | 2 |
| 4 | 2 | 1, 9 | 1 | 4 | 2 | (0, 1, 2, 8, 10) | 1 |
| 5 | 2 | 2, 10 | 1 | 5 | 2 | (0, 1, 2, 3, 8, 10) | 1 |
| 6 | 2 | 3, 11 | 1 | 6 | 2 | (0, 1, 2, 3, 8, 9, 10) | 1 |
| 7 | 2 | (0, 1), (8, 9) | 1 | 7 | 2 | (0-3, 8-11) | 1 |
| 8 | 2 | (2, 3), (10, 11) | 1 | 8 | 2 | (8-12) | 2 |
| 9 | 2 | (0-2), (8-10) | 1 | 9 | 2 | (8, 9, 10, 11, 12, 14) | 2 |
| 10 | 2 | (0-3), (8-11) | 1 | 10 | 2 | (8-14) | 2 |
| 11 | 2 | (0, 2), (8, 10) | 1 | 11 | 2 | (8-15) | 2 |
| 12 | 2 | 0, 8 | 2 | 12-31 | Reserved | Reserved | reserved |
| 13 | 2 | 1, 9 | 2 | | | | |
| 14 | 2 | 2, 10 | 2 | | | | |
| 15 | 2 | 3, 11 | 2 | | | | |
| 16 | 2 | 4. 12 | 2 | | | | |
| 17 | 2 | 5, 13 | 2 | | | | |
| 18 | 2 | 6, 14 | 2 | | | | |
| 19 | 2 | 7, 15 | 2 | | | | |
| 20 | 2 | (0, 1), (8, 9) | 2 | | | | |
| 21 | 2 | (2, 3), (10, 11) | 2 | | | | |
| 22 | 2 | (4, 5), (12, 13) | 2 | | | | |
| 23 | 2 | (6, 7), (14, 15) | 2 | | | | |
| 24 | 2 | (0, 4), (8, 12) | 2 | | | | |
| 25 | 2 | (2, 6), (10, 14) | 2 | | | | |
| 26 | 2 | (0, 1, 4), | 2 | | | | |
| | | (8, 9, 12) | | | | | |
| 27 | 2 | (2, 3, 6), | 2 | | | | |
| | | (10, 11, 14) | | | | | |
| 28 | 2 | (0, 1, 4, 5), | 2 | | | | |
| | | (8, 9, 12, 13) | | | | | |
| 29 | 2 | (2, 3, 6, 7), | 2 | | | | |
| | | (10, 11, 14, 15) | | | | | |
| 30 | 2 | (0, 2, 4, 6), | 2 | | | | |
| | | (8, 10, 12, 14) | | | | | |
| 31 | 1 | (0, 1, 8), | 1 | | | | |
| | | (0, 1, 8, 9) | | | | | |

DMRS port mapping configurations for increased quantities of orthogonal DMRS ports may additionally or alternatively be implemented in the context of DMRS Type 2. For example, a DMRS port mapping configuration for DMRS Type 2 and an FD-OCC sequence length of four (=4) is illustrated in Tables 13 and 14 below:

TABLE 13
DMRS Port Mappings (N = 4, DMRS Type 2)

| | | | | wₜ |
|---|---|---|---|---|
| | CDM | | | I′ = 0, |
| Port | Group | α(p) | w_{f}(α, k′) | I′ = 1 |
| 1000 | 0 | 0 | [1 1 1 1] | [1 1] |
| 1001 | 0 | π | [1 −1 1 −1] | [1 1] |
| 1002 | 1 | 0 | [1 1 1 1] | [1 1] |
| 1003 | 1 | π | [1 −1 1 −1] | [1 1] |
| 1004 | 2 | 0 | [1 1 1 1] | [1 1] |
| 1005 | 2 | π | [1 −1 1 −1] | [1 1] |
| 1006 | 0 | 0 | [1 1 1 1] | [1 −1] |
| 1007 | 0 | π | [1 −1 1 −1] | [1 −1] |
| 1008 | 1 | 0 | [1 1 1 1] | [1 −1] |
| 1009 | 1 | π | [1 −1 1 −1] | [1 −1] |
| 1010 | 2 | 0 | [1 1 1 1] | [1 −1] |
| 1011 | 2 | π | [1 −1 1 −1] | [1 −1] |
| 1012 | 0 | π/2 | [1 +j −1 −j] | [1 1] |
| 1013 | 0 | 3π/2 | [1 −j −1 +j] | [1 1] |
| 1014 | 1 | π/2 | [1 +j −1 −j] | [1 1] |
| 1015 | 1 | 3π/2 | [1 −j −1 +j] | [1 1] |
| 1016 | 2 | π/2 | [1 +j −1 −j] | [1 1] |
| 1017 | 2 | 3π/2 | [1 −j −1 +j] | [1 1] |
| 1018 | 0 | π/2 | [1 +j −1 −j] | [1 −1] |
| 1019 | 0 | 3π/2 | [1 −j −1 +j] | [1 −1] |
| 1020 | 1 | π/2 | [1 +j −1 −j] | [1 −1] |
| 1021 | 1 | 3π/2 | [1 −j −1 +j] | [1 −1] |
| 1022 | 2 | π/2 | [1 +j −1 −j] | [1 −1] |
| 1023 | 2 | 3π/2 | [1 −j −1 +j] | [1 −1] |

TABLE 14
DMRS Port Mappings (4 FD-OCC, DMRS Type 2)

| | | | | wₜ |
|---|---|---|---|---|
| | CDM | FD Sequence | | I′ = 0, |
| Port | Group | ID (αᵢ) | w_{f}(α, k′) | I′ = 1 |
| 1000 | 0 | 0 | [1 1 1 1] | [1 1] |
| 1001 | 0 | 1 | [1 −1 1 −1] | [1 1] |
| 1002 | 1 | 0 | [1 1 1 1] | [1 1] |
| 1003 | 1 | 1 | [1 −1 1 −1] | [1 1] |
| 1004 | 2 | 0 | [1 1 1 1] | [1 1] |
| 1005 | 2 | 1 | [1 −1 1 −1] | [1 1] |
| 1006 | 0 | 0 | [1 1 1 1] | [1 −1] |
| 1007 | 0 | 1 | [1 −1 1 −1] | [1 −1] |
| 1008 | 1 | 0 | [1 1 1 1] | [1 −1] |
| 1009 | 1 | 1 | [1 −1 1 −1] | [1 −1] |
| 1010 | 2 | 0 | [1 1 1 1] | [1 −1] |
| 1011 | 2 | 1 | [1 −1 1 −1] | [1 −1] |
| 1012 | 0 | 2 | [+1 +1 −1 −1] | [1 1] |
| 1013 | 0 | 3 | [+1 −1 −1 +1] | [1 1] |
| 1014 | 1 | 2 | [+1 +1 −1 −1]] | [1 1] |
| 1015 | 1 | 3 | [+1 −1 −1 +1] | [1 1] |
| 1016 | 2 | 2 | [+1 +1 −1 −1] | [1 1] |
| 1017 | 2 | 3 | [+1 −1 −1 +1] | [1 1] |
| 1018 | 0 | 2 | [+1 +1 −1 −1] | [1 −1] |
| 1019 | 0 | 3 | [+1 −1 −1 +1] | [1 −1] |
| 1020 | 1 | 2 | [+1 +1 −1 −1] | [1 −1] |
| 1021 | 1 | 3 | [+1 −1 −1 +1] | [1 −1] |
| 1022 | 2 | 2 | [+1 +1 −1 −1] | [1 −1] |
| 1023 | 2 | 3 | [+1 −1 −1 +1] | [1 −1] |

In Table 13 above, the DMRS ports 1000-1004 and 1012-1017 include ports for a single symbol. Moreover, as shown in Table 13 above, antenna ports 1000, 1001, 1006, 1007, 1012, 1013, 1018, and 1019 (corresponding to DMRS ports 0, 1, 6, 7, 12, 13, 18, and 19) are associated with CDM group 0, antenna ports 1002, 1003, 1008, 1009, 1014, 1015, 1020, and 1021 (corresponding to DMRS ports 2, 3, 8, 9, 14, 15, 20, and 21) are associated with CDM group 1, and antenna ports 1042, 1005, 1010, 1011, 1016, 1017, 1022, and 1023 (corresponding to DMRS ports 4, 5, 10, 11, 16, 17, 22, and 23) are associated with CDM group 2. Table 14 shows another design example using similar methodology of DMRS ports mapping illustrated in Table 13, with the difference of using 4 FD-OCC (Walsh code) instead of using 4 CS.

In some aspects, DMRS port mapping configurations to CDM groups and codeword(s) described herein may be implemented to support increased quantities of orthogonal DMRS ports, as illustrated in Tables 15 and 16 below for both DMRS Type 1 and Type 2 respectively:

TABLE 15
DMRS Port Mapping for Increased Numbers of Ports (DMRS Type 1, Two Codewords)

| | # of | | | | |
|---|---|---|---|---|---|
| | DMRS | | | | |
| Antenna | CDM | | # of Layers/ | # of Layers/ | # of |
| Port | Group(s) | Total | DMRS port(s)/ | DMRS port(s)/ | front- |
| Field | Without | # of | CDM Group for | CDM Group for | loaded |
| Value | Data | Layers | Codeword 0 | Codeword 1 | symbols |
| 0 | 2 | 5 | 2/(0, 1)/(2, 3)/(1, 1) | 3/(2, 3, 4)/(0, 1, 4)/(0, 0, 0) | 2 |
| 1 | 2 | 6 | 3/(0, 1, 2)/(0, 1, 4)/(0, 0, 0) | 3/(3, 4, 5)/(2, 3, 6)/(1, 1, 1) | 2 |
| 2 | 2 | 7 | 3/(0, 1, 2)/(2, 3, 6)/(1, 1, 1) | 4/(3, 4, 5, 6)/(0, 1, 4, 5)/(0, 0, 0, 0) | 2 |
| 3 | 2 | 8 | 4/(0, 1, 2, 3)/(0, 1, 4, 5)/(0, 0, 0, 0) | 4/(4, 5, 6, 7)/(2, 3, 6, 7)/(1, 1, 1, 1) | 2 |
| 4 | 2 | 5 | 2/ (0, 1)/(2, 10)/(1, 1) | 3/(2, 3, 4)/(0, 1, 8)/(0, 0, 0) | 1 |
| 5 | 2 | 6 | 3/(0, 1, 2)/(0, 1, 8)/(0, 0, 0) | 3/(3, 4, 5)/(2, 3, 10)/(1, 1, 1) | 1 |
| 6 | 2 | 7 | 3/(0, 1, 2)/(2, 3, 10)/(1, 1, 1) | 4/(3, 4, 5, 6)/(0, 1, 8, 9)/(0, 0, 0, 0) | 1 |
| 7 | 2 | 8 | 4/(0, 1, 2, 3)/(0, 1, 8, 9)/(0, 0, 0, 0) | 4/(4, 5, 6, 7)/(2, 3, 10, 11)/(1, 1, 1, 1) | 1 |
| 8 | 2 | 5 | 2/(0, 1)/(10, 11)/(1, 1) | 3/(2, 3, 4)/(8, 9, 12)/(0, 0, 0) | 2 |
| 9 | 2 | 6 | 3/(0, 1, 2)/(8, 9, 12)/(0, 0, 0) | 3/(3, 4, 5)/(10, 11, 14)/(1, 1, 1) | 2 |
| 10 | 2 | 7 | 3/(0, 1, 2)/(10, 11, 14)/(1, 1, 1) | 4/(3, 4, 5, 6)/(8, 9, 12, 13)/(0, 0, 0, 0) | 2 |
| 11 | 2 | 8 | 4/(0, 1, 2, 3)/(8, 9, 12, 13)/(0, 0, 0, 0) | 4/(4, 5, 6, 7)/(10, 11, 14, 15)/(1, 1, 1, 1) | 2 |
| 12-31 | Reserved | Reserved | Reserved | Reserved | Reserved |

TABLE 16
DMRS Port Mapping for Increased Numbers of Ports (DMRS Type 2, Two Codewords)

| | # of | | | | |
|---|---|---|---|---|---|
| | DMRS | | | | |
| Antenna | CDM | | # of Layers/ | # of Layers/ | # of |
| Port | Group(s) | Total | DMRS port(s)/ | DMRS port(s)/ | front- |
| Field | Without | # of | CDM Group for | CDM Group for | loaded |
| Value | Data | Layers | Codeword 0 | Codeword 1 | symbols |
| 0 | 3 | 5 | 2/(0, 1)/(0, 1)/(0, 0) | 3/(2, 3, 4)/(2, 3, 4)/(1, 1, 2) | 1 |
| [symbol] | [symbol] | [symbol] | [symbol] | [symbol] | [symbol] |
| 2 | 2 | 5 | 2/(0, 1)/(2, 3)/(1, 1) | 3/(2, 3, 4)/(0, 1, 6)/(0, 0, 0) | 2 |
| 3 | 2 | 6 | 3/(0, 1, 2)/(0, 1, 6)/(0, 0, 0) | 3/(3, 4, 5)/(2, 3, 8)/(1, 1, 1) | 2 |
| 4 | 2 | 7 | 3/(0, 1, 2)/(2, 3, 8)/(1, 1, 1) | 4/(3, 4, 5, 6)/(0, 1, 6, 7)/(0, 0, 0, 0) | 2 |
| 5 | 2 | 8 | 4/(0, 1, 2, 3)/(0, 1, 6, 7)/(0, 0, 0, 0) | 4/(4, 5, 6, 7)/(2, 3, 6, 7)/(1, 1, 1, 1) | 2 |
| 6 | 3 | 5 | 2/(0, 1)/(0, 1)/(0, 0) | 3/(2, 3, 4)/(2, 3, 14)/(1, 1, 1) | 1 |
| 7 | 3 | 6 | 3/(0, 1, 2)/(0, 1, 12)/(0, 0, 0) | 3/(3, 4, 5)/(2, 3, 14)/(1, 1, 1) | 1 |
| 8 | 2 | 5 | 2/(0, 1)/(14, 15)/(1, 1) | 3/(2, 3, 4)/(12, 13, 18)/(0, 0, 0) | 2 |
| 9 | 2 | 6 | 3/(0, 1, 2)/(12, 13, 18)/(0, 0, 0) | 3/(3, 4, 5)/(14, 15, 20)/(1, 1, 1) | 2 |
| 10 | 2 | 7 | 3/(0, 1, 2)/(14, 15, 20)/(1, 1, 1) | 4/(3, 4, 5, 6)/(12, 13, 18, 19)/(0, 0, 0, 0) | 2 |
| 11 | 2 | 8 | 4/(0, 1, 2, 3)/(12, 13, 18, 19)/(0, 0, 0, 0) | 4/(4, 5, 6, 7)/(14, 15, 18, 19)/(1, 1, 1, 1) | 2 |
| 12-63 | Reserved | Reserved | Reserved | Reserved | Reserved |

In particular, Table 15 above illustrates a DMRS port mapping configuration of the present disclosure for DMRS Type 1 with two codewords, where Table 16 above illustrates a DMRS port mapping configuration of the present disclosure for DMRS Type 2 with two codewords. As may be seen in Tables 15 and 16 above, the DMRS port mapping configurations described herein may enable DMRS ports belonging to the same CDM groups to be assigned to the same codeword, even for increased quantities of orthogonal DMRS ports.

In particular, with the exception of antenna port field value=1 in Table 16, the DMRS port mapping configurations illustrated in Tables 15 and 16 may include or define mappings for each respective antenna port field value, where Codeword 0 includes a first mapping (for each antenna port field value) between Codeword 0 and one or more DMRS ports corresponding to a respective CDM group(s), and a second mapping (for each antenna port field value) between Codeword 1 and one or more DMRS ports corresponding to a respective CDM group(s). In other words, with the exception of antenna port field value=1 in Table 16, the DMRS port mapping configurations illustrated in Tables 15 and 16 define mappings such that no CDM group (e.g., CDM group 0, 1, 2) includes DMRS ports which belong to both Codeword 0 and Codeword 1. As such, the DMRS port mapping configurations illustrated in Tables 15 and 16 may enable channel estimation for each CDM group across both codewords/TRPs at a receiving device (e.g., UE 115).

The port mapping for a single symbol described herein may be backwards-compatible with legacy UEs 115. For example, port mapping for sequence length four (e.g., N=4) CS, single symbol DMRS Type 1 (8 DMRS ports in total) may be illustrated in Table 17 below:

TABLE 17
Port Mapping for Single Symbol (N = 4, Type-1)

| (pᵢ − 1000) | αᵢ |
|---|---|
| 0, 2 | 0 |
| 1, 3 | π |
| 8, 10 | π/2 |
| 9, 11 | 3π/2 |

where phase shifts aᵢ for the port mapping may be determined according to Equations 2 and 3 below:

$${a}_{i} = 2 {t}_{i} + 1 + mod\_ 2 ( {m}_{i} ) \qquad ( 2 )$$

$$( {p}_{i} - 1000 ) = 4 ( DMRStype + 1 ) * {t}_{i} + {m}_{i} \qquad ( 3 )$$

for port identifiers pᵢ (port ids) of {1000, 1001, 1002, . . . }, where tᵢ is the largest integer divisor, and mᵢ is the remainder. For double symbols, the same CS may be maintained over time, and TD-OCC may be applied for spreading over time. Moreover, similar to SRS, different CS values may be assigned to different ports, where only the port assignment is different to maintain backwards compatibility.

Techniques described herein for DMRS port mapping configurations for increased CS length (e.g., increased N) may be scalable to any arbitrary N. The rows of Table 17 above (e.g., the respective phase shift values aᵢ) may correspond to the following Walsh sequences:

$$\begin{matrix}{α}_{i} = 0 ⟶ [ \begin{matrix}+ 1 & + 1 & + 1 & + 1\end{matrix} ] \\ {α}_{i} = π ⟶ [ \begin{matrix}+ 1 & - 1 & + 1 & - 1\end{matrix} ] \\ {α}_{i} = π / 2 ⟶ [ \begin{matrix}+ 1 & + j & - 1 & - j\end{matrix} ] \\ {α}_{i} = 3 π / 2 ⟶ [ \begin{matrix}+ 1 & - j & - 1 & + j\end{matrix} ]\end{matrix}$$

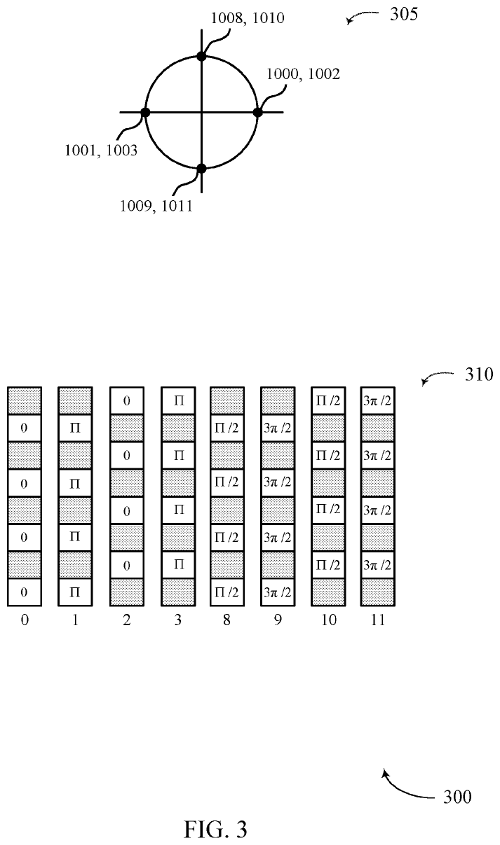

As such, it may be seen that the first two rows of Table 17 above corresponding to aᵢ=0 and w are the same as legacy port mapping. The port mapping illustrated in Table 17 for N=4 may be further shown and described in FIG. 3.

FIG. 3 illustrates an example of a DMRS port mapping configuration 300 that supports techniques for multi-codeword communications using CDM group-based DMRS port mapping in accordance with aspects of the present disclosure. In some examples, DMRS port mapping configuration 300 may implement, or be implemented by, aspects of wireless communications system 100, wireless communications system 200, or both. In particular, the phase shift configuration 305 and the DMRS pattern 310 may be implemented in accordance with aspects of the present disclosure to support DMRS port mapping configurations for increased quantities of orthogonal DMRS ports.

The DMRS port mapping configuration 300 for a single symbol for CS-based sequence length four (e.g., N=4), type-1 (8 DMRS ports in total) may be illustrated via the phase shift configuration 305 and the DMRS pattern 310. Referring to the DMRS pattern 310, the first four ports/columns (e.g., ports/columns 0-3) may be the same as the legacy port mapping for FD-OCC length two (e.g., same for N=2). As such, techniques described herein may enable new port mappings which are illustrated in the last four ports/columns (e.g., ports/columns 8-11) of the DMRS pattern 310. Moreover, the DMRS pattern 310 may be scalable to any N.

The port mapping for double symbols described herein may be backwards-compatible with legacy UEs 115, which may be scalable to an arbitrary N. For example, using Equations 2 and 3 above for FD-OCC length four (e.g., N=4) CS, double symbol DMRS Type 1 (16 DMRS ports in total) may be illustrated in Table 18 below:

TABLE 18
Port Mapping for Double Symbol (N = 4, Type-1)

| (pᵢ − 1000) | αᵢ |
|---|---|
| 0, 2, 4, 6 | 0 |
| 1, 3, 5, 7 | π |
| 8, 10, 12, 14 | π/2 |
| 9, 11, 13, 15 | 3π/2 |

The rows of Table 18 above (e.g., the respective phase shift values a₁) may correspond to the following Walsh sequences:

$$\begin{matrix}{α}_{i} = 0 ⟶ [ \begin{matrix}+ 1 & + 1 & + 1 & + 1\end{matrix} ] \\ {α}_{i} = π ⟶ [ \begin{matrix}+ 1 & - 1 & + 1 & - 1\end{matrix} ] \\ {α}_{i} = π / 2 ⟶ [ \begin{matrix}+ 1 & + j & - 1 & - j\end{matrix} ] \\ {α}_{i} = 3 π / 2 ⟶ [ \begin{matrix}+ 1 & - j & - 1 & + j\end{matrix} ]\end{matrix}$$

As such, it may be seen that the first two rows of Table 18 above corresponding to aᵢ=0 and w are the same as legacy port mapping. Moreover, for double symbol port mapping, within each CS, DMRS ports may be grouped into CDM and TDM such that legacy mapping may be preserved, as shown in Table 19 below:

TABLE 19
CDM/TDM Group Mapping for Double Symbol

| | 1000 | 1002 | 1004 | 1006 |
|---|---|---|---|---|
| CDM Group | 0 | 1 | 0 | 1 |
| TDM Group | 0 | 0 | 1 | 1 |

where TDM group 0 may be represented by a sequence multiplied by (+1) (e.g., +exp (jaᵢ,n)), and where TDM group 1 may be represented by a sequence multiplied by (−1) (e.g., −exp (jaᵢ,n)).

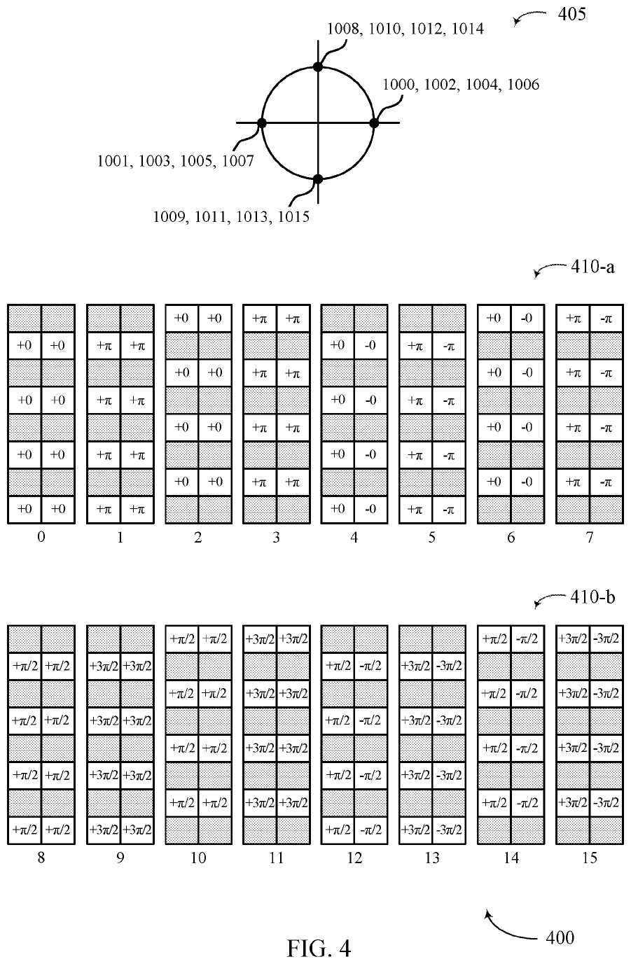

The port mappings for double symbols illustrated in Tables 18 and 19 above may be further shown and described with reference to FIG. 4.

FIG. 4 illustrates an example of a DMRS port mapping configuration 400 that supports techniques for multi-codeword communications using CDM group-based DMRS port mapping in accordance with aspects of the present disclosure. In some examples, DMRS port mapping configuration 400 may implement, or be implemented by, aspects of wireless communications system 100, wireless communications system 200, DMRS port mapping configuration 400, or any combination thereof. In particular, the phase shift configuration 405 and the DMRS port mapping configurations 410-a, 410-b maybe implemented in accordance with aspects of the present disclosure to support DMRS port mapping configurations for increased quantities of orthogonal DMRS ports.

Specifically, the first DMRS port mapping configuration 410-a in FIG. 4 illustrates legacy port mapping, whereas the second DMRS port mapping configuration 410-b illustrates an example port mapping for N=4 double symbols (e.g., CS+comb 2+TD-OCC). The “+” and “−” signs in the DMRS port mapping configurations 410 represent+exp (jaᵢn) and −exp (jaᵢn), respectively.

The port mapping for a single symbol described herein may be backwards-compatible with legacy UEs 115. For example, using Equations 2 and 3 above for FD-OCC length four (e.g., N=4) CS, type-1 (8 DMRS ports in total) may be illustrated in Table 20 below:

TABLE 20
Port Mapping for Single Symbol (N = 4, Type-1)

| (pᵢ − 1000) | αᵢ |
|---|---|
| 0, 2 | 0 |
| 1, 3 | π |
| 8, 10 | π/2 |
| 9, 11 | 3π/2 |

Techniques described herein for increasing FD-OCC length (e.g., increasing N) may be scalable to any arbitrary N, as will be described in further detail herein. The rows of Table 20 above (e.g., the respective phase shift values aᵢ) may correspond to the following Walsh sequences:

$$\begin{matrix}{α}_{i} = 0 ⟶ [ \begin{matrix}+ 1 & + 1 & + 1 & + 1\end{matrix} ] \\ {α}_{i} = π ⟶ [ \begin{matrix}+ 1 & - 1 & + 1 & - 1\end{matrix} ] \\ {α}_{i} = π / 2 ⟶ [ \begin{matrix}+ 1 & + j & - 1 & - j\end{matrix} ] \\ {α}_{i} = 3 π / 2 ⟶ [ \begin{matrix}+ 1 & - j & - 1 & + j\end{matrix} ]\end{matrix}$$

As such, it may be seen that the first two rows of Table 20 above corresponding to aᵢ=0 and w are the same as legacy port mapping.

Techniques described herein may enable mTRP communications using multiple codewords. In particular, the DMRS port mapping configurations described herein may map DMRS ports corresponding to respective CDM groups to individual codewords so that DMRSs for the respective codewords which are transmitted using different TRPs may be separable at the receiver device. Accordingly, by enabling mTRP DMRS transmissions associated with multiple codewords to be efficiently decoded at receiver devices, techniques described herein may facilitate mTRP channel estimation at the receiver device, which may facilitate more efficient and reliable wireless communications.

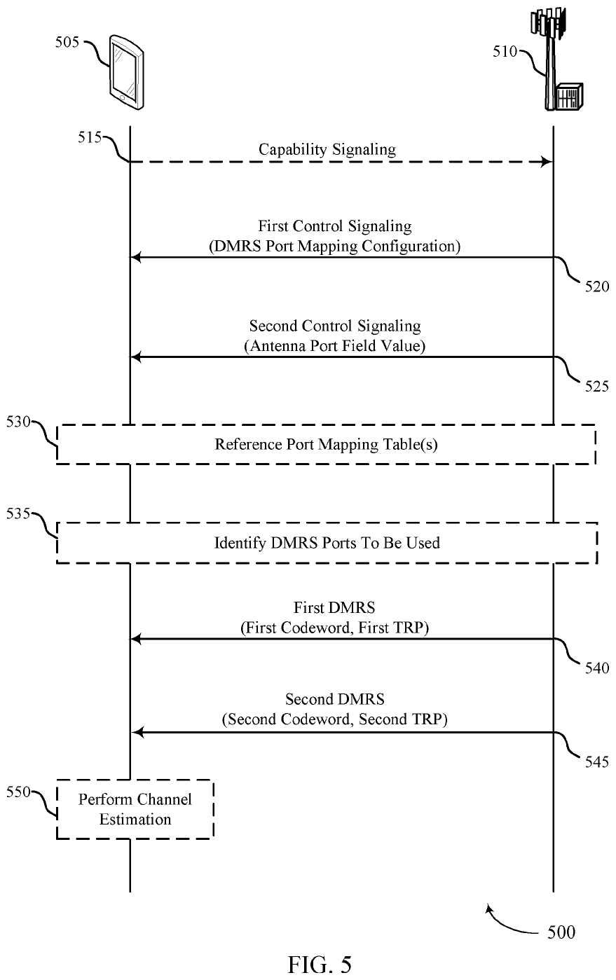

FIG. 5 illustrates an example of a process flow 500 that supports techniques for multi-codeword communications using CDM group-based DMRS port mapping in accordance with aspects of the present disclosure. In some examples, process flow 500 may implement, or be implemented by, aspects of wireless communications system 100, wireless communications system 200, DMRS port mapping configuration 300, DMRS port mapping configuration 400, or any combination thereof. For example, the process flow 500 may illustrate a UE 505 receiving an indication of DMRS port mapping configuration from a base station 510, receiving an indication of an antenna port field value, identifying DMRS ports in accordance with the DMRS port mapping configuration and the antenna port field value, and receiving DMRSs using the identified DMRS ports, as described with reference to FIGS. 1-4.

In some cases, process flow 500 may include a UE 505 and a base station 510, which may be examples of corresponding devices as described herein. In particular, the UE 505 and the base station 510 illustrated in FIG. 5 may include examples of the UE 115 and the base station 105 illustrated in FIG. 2.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 515, the UE 505 may transmit capability signaling (e.g., UE capability signaling) to the base station 510. In some aspects, the capability signaling may indicate a capability of the UE 505 to communicate in accordance with DMRS port mapping configurations of the present disclosure. In this regard, the capability signaling may indicate a capability of the UE 505 to communicate in accordance with DMRS port mapping configurations which include/define mappings between codewords (e.g., Codeword 0, Codeword 1) and DMRS ports associated with respective CDM groups, as shown in Tables 6 and 7, for example. The capability signaling may indicate a capability of the UE 505 to support the DMRS port mapping configurations described herein in addition to legacy DMRS port mapping configurations, as shown in Tables 2-5, for example.

In some implementations, the capability signaling at 515 may indicate that the UE 505 is capable of performing communications in accordance with the DMRS port mapping configurations described herein within particular frequency bands (e.g., BWPs), component carriers, cells, and the like. In other words, DMRS port mapping configurations may be supported at the UE 505 for individual BWPs, component carriers, cells, and the like (e.g., capability per-band, per-BWP, per-component carrier). In this regard, the capability signaling may indicate one or more frequency bands, component carriers, or both, which are associated with the capability of the UE 505 to communicate in accordance with the DMRS port mapping configurations, as shown in Tables 6 and 7, for example.

At 520, the UE 505 may receive, from the base station 510, first control signaling that indicates a DMRS port mapping configuration. The first control signaling may include an RRC message, a MAC-CE message, or both. In some aspects, the UE 505 may receive the first control signaling based on (e.g., in response to) transmitting the capability signaling indicating the capability of the UE 505 to communicate in accordance with the DMRS port mapping configuration. For example, in some cases, the first control signaling may confirm and/or activate the DMRS port mapping configuration in response to the capability signaling at 515.

In some aspects, the DMRS port mapping configuration may be associated with a set of antenna port field values. As described previously herein, for each antenna port field value, the DMRS port mapping configuration may include/define a first mapping between a first codeword (e.g., Codeword 0) and one or more DMRS ports corresponding to a first CDM group, and a second mapping between a second codeword (e.g., Codeword 1) and one or more DMRS ports corresponding to a second CDM group. For example, as shown in Table 6 above, for each of the antenna port field values=0-3, the DMRS port mapping configuration may define a first mapping between Codeword 0 and DMRS ports corresponding to a respective CDM group, and a second mapping between Codeword 1 and DMRS ports corresponding to a respective CDM group.

For instance, referring to antenna port field value=0 in Table 6, the DMRS port mapping configuration may include/define a first mapping between Codeword 0 and DMRS ports 2 and 3 corresponding to CDM group 1, and a second mapping between Codeword 1 and DMRS ports 0, 1, and 4 corresponding to CDM group 0. By way of another example, referring to antenna port field value=0 in Table 7, the DMRS port mapping configuration may include/define a first mapping between Codeword 0 and DMRS ports 0 and 1 corresponding to CDM group 0, a second mapping between Codeword 1 and DMRS ports 2 and 3 corresponding to CDM group 1, and a third mapping between Codeword 1 and DMRS port 4 corresponding to CDM group 2. In general, the DMRS port mapping configuration may include/define mappings between codewords and DMRS ports such that DMRS ports corresponding to a single CDM group are only associated with a single codeword (e.g., DMRS ports for a given CDM group do not correspond to multiple codewords).

As noted previously herein, the DMRS port mapping configuration may be implemented/reflected in new DMRS port mapping tables, as shown in Tables 6 and 7 above. In additional or alternative implementations, the DMRS port mapping configuration may be implemented by re-purposing unused/reserved antenna port field values in legacy DMRS port mapping tables. For example, in some cases, the DMRS port mapping configuration may be implemented within legacy DMRS port mapping configurations shown in Tables 4 and 5 above by re-purposing reserved antenna port field values 4-31 in Table 4 and/or reserved antenna port field values 6-63 in Table 5.

At 525, the UE 505 may receive, from the base station 510, second control signaling that indicates an antenna port field value included within the set of antenna port field values associated with the DMRS port mapping configuration. For example, in cases where the first control signaling at 520 configures the DMRS port mapping configuration illustrated in Table 6, the second control signaling may indicate one of the antenna port field values 0 through 3 which will be used for DMRSs exchanged between the UE 505 and the base station 510. In some aspects, the second control signaling may include a DCI message, a MAC-CE message, or both. The UE 505 may receive the second control signaling at 525 based on transmitting the capability signaling at 515, receiving the first control signaling at 520, or both.

In some aspects, the first control signaling, the second control signaling, or both, may schedule one or more DMRS transmissions which are to be performed in accordance with the indicated DMRS port mapping configuration and/or antenna port field value. For example, the second control signaling (e.g., DCI message) may indicate a set of resources which will be used to perform (e.g., transmit, receive) one or more DMRS transmissions. In this example, one or more DMRS transmissions scheduled by the second control signaling may be performed in accordance with the DMRS port mapping configuration indicated via the first control signaling, and the antenna port field value indicated via the second control signaling.

In cases where the UE 505 is configured with multiple candidate DMRS port mapping tables (e.g., legacy DMRS port mapping tables and new DMRS port mapping tables), the second control signaling may additionally indicate which DMRS port mapping table is to be used. For example, the UE 505 may be configured with legacy port mapping tables shown in Tables 4 and 5, and new port mapping tables shown in Tables 6 and 7. In such cases, the second control singling may indicate which port mapping table is to be used, as well as the applicable antenna port field value within the respective table.

At 530, the UE 505, the base station 510, or both, may reference one or more port mapping tables associated with the indicated DMR port mapping configuration in order to identify DMRS ports which will be used to transmit/receive scheduled DMRS transmissions. The UE 505 and the base station 510 may reference the port mapping table(s) based on the first control signaling, the second control signaling, or both. In particular, the UE 505 and/or the base station 510 may reference one or more port mapping tables associated with the indicated DMRS port mapping configuration based on the antenna port field value indicated via the second control signaling. For example, the second control singling may indicate that the DMRS port mapping configuration corresponds to Table 7 above, and may further indicate antenna port field value=2. In this example, the UE 505 and the base station 510 may reference Table 7 by indexing the table according to antenna port field value=2.

At 535, the UE 505, the base station 510, or both, may identify one or more DMRS ports which will be used to perform (e.g., transmit, receive) the scheduled DMRS transmission(s). For example, in cases where the base station 510 schedules a first DMRS and a second DMRS, the UE 505 and the base station 510 may identify a first set of DMRS ports associated with the first DMRS, and a second set of DMRS ports associated with the second DMRS. In some aspects, the UE 505 and the base station 510 may identify the DMRS port(s) which are to be used based on transmitting/receiving the capability signaling at 515, transmitting/receiving the first control signaling at 520, transmitting/receiving the second control signaling at 525, referencing the port mapping table(s) at 530, or any combination thereof.

At 540, the UE 505 may receive a first DMRS from the base station 510. Similarly, at 545, the UE 505 may receive a second DMRS from the base station 510. The UE 505 may receive, and the base station 510 may transmit, the first and second DMRSs at 540 and 545 based on transmitting/receiving the capability signaling at 515, transmitting/receiving the first control signaling at 520, transmitting/receiving the second control signaling at 525, referencing the port mapping table(s) at 530, identifying the DMRS port(s) which are to be used at 535, or any combination thereof. For example, the UE 505 may receive, and the base station 510 may transmit, the first and second DMRSs in accordance with the DMRS port mapping configuration (e.g., in accordance with the mappings defined by the DMRS port mapping configuration) and the indicated antenna port field value.

In some aspects, the first and second DMRSs may be associated with (e.g., include) different codewords. For example, in some cases, the first DMRS may be associated with/include Codeword 0, and the second DMRS may be associated with/include Codeword 1. The first and second DMRSs may be transmitted/received based on (e.g., in accordance with) the DMRS ports identified at 535. Moreover, in some implementations, the first DMRS may be transmitted via a first TRP at the base station 510, where the second DMRS may be transmitted via a second TRP at the base station 510. In such cases, the first and second TRPs may be spatially separated at the base station 510. Additionally, or alternatively, the first and second TRPs may be co-located at the base station 510.

For example, continuing with the example above, the second control singling may indicate that the DMRS port mapping configuration corresponds to Table 7 above, and may further indicate antenna port field value=2. In this example, the UE 505 may receive the first DMRS including Codeword 0 using DMRS ports 2 and 3 corresponding to CDM group 1 in accordance with a first mapping for Codeword 0 defined by the DMRS port mapping configuration. Similarly, the UE 505 may receive the second DMRS including Codeword 1 using DMRS ports 0, 1, and 6 corresponding to CDM group 0 in accordance with a second mapping for Codeword 1 defined by the DMRS port mapping configuration. In this example, the first DMRS including Codeword 0 may be transmitted by via the first TRP at the base station 510, and the second DMRS including Codeword 1 may be transmitted by via the second TRP at the base station 510. Moreover, in this example, the first DMRS may be associated with (e.g., include) to layers, where the second DMRS may be associated with three layers, as shown in Table 7.

By way of another example, the second control singling may indicate that the DMRS port mapping configuration corresponds to Table 7 above, and may further indicate antenna port field value=0. In this example, the UE 505 may receive the first DMRS including Codeword 0 using DMRS ports 0 and 1 corresponding to CDM group 0 in accordance with a first mapping for Codeword 0 defined by the DMRS port mapping configuration. Similarly, the UE 505 may receive the second DMRS including Codeword 1 using DMRS ports 2 and 3 corresponding to CDM group 1 in accordance with a second mapping for Codeword 1 defined by the DMRS port mapping configuration. Further, the UE 505 may receive the second DMRS including Codeword 1 using DMRS port 4 corresponding to CDM group 2 in accordance with a third mapping for Codeword 1 defined by the DMRS port mapping configuration. In this example, the first DMRS including Codeword 0 may be transmitted by via the first TRP at the base station 510, and the second DMRS including Codeword 1 may be transmitted by via the second TRP at the base station 510. Moreover, in this example, the first DMRS may be associated with (e.g., include) to layers, where the second DMRS may be associated with three layers, as shown in Table 7.

In some aspects, the UE 505 may receive (and the base station 510 may transmit) the first and second DMRSs within sets of resources indicated via the second control signaling at 525. For example, the second control signaling (e.g., DCI message) may indicate one or more sets of resources which will be used to transmit/receive the first and second DMRSs. Further, in cases where the capability signaling at 515 indicates frequency bands and/or component carriers in which the UE 505 supports communications in accordance with the DMRS port mapping configuration, the DMRSs may be transmitted/received within the indicated frequency bands/component carriers.

At 550, the UE 505 may perform channel estimation procedures based on the received DMRSs. For example, in cases where the first and second DMRSs are transmitted via first and second TRPs at the base station 510, respectively, the UE 505 may determine a first channel estimate associated with a first channel between the UE 505 and the first TRP based on the first codeword (and corresponding CDM groups) of the first DMRS, and may determine a second channel estimate associated with a second channel between the UE 505 and the second TRP based on the second codeword (and corresponding CDM groups) of the second DMRS. As noted previously herein, the DMRS port mapping configurations described herein may ensure that DMRS ports corresponding to each respective CDM group correspond to a single codeword, thereby enabling the separate DMRSs/codewords to be separable at the UE 505 to enable channel estimation.

In some implementations, the UE 505 may determine the channel estimates for the respective channels/TRPs/DMRSs based on TRSs for the respective TRPs. TRSs may be used to determine parameters associated with the channels for the respective TRPs, such as doppler shift, average delay, modulation (e.g., MCS), and the like. For example, in cases where the first and second DMRSs are transmitted via first and second TRPs at the base station 510, respectively, the UE 505 may determine a first channel estimate associated with the first TRP based on a first TRS associated with the first TRP, and may determine a second channel estimate associated with and the second TRP based on a second TRS associated with the second TRP. In cases where the first and second TRPs are co-located at the base station 510, the UE 505 may determine the respective channel estimates based on a single TRS associated with the co-located TRPs.

Techniques described herein may enable mTRP communications using multiple codewords. In particular, the DMRS port mapping configurations described herein may map DMRS ports corresponding to respective CDM groups to individual codewords so that DMRSs for the respective codewords which are transmitted using different TRPs may be separable at the receiver device. Accordingly, by enabling mTRP DMRS transmissions associated with multiple codewords to be efficiently decoded at receiver devices, techniques described herein may facilitate mTRP channel estimation at the receiver device, which may facilitate more efficient and reliable wireless communications.

Techniques described by FIG. 5 are applicable for uplink communication from the UE to the multi-TRP, where each DMRS CDM group is assigned to a specific TRP for uplink data communication.

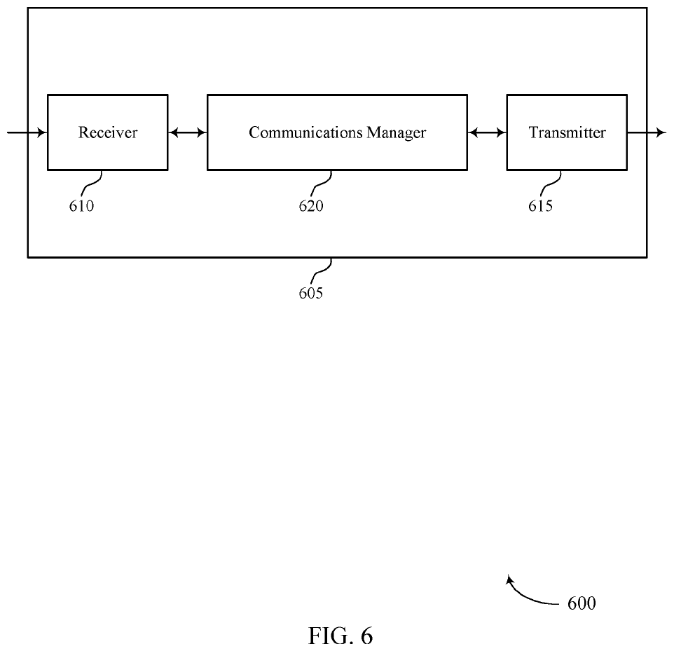

FIG. 6 shows a block diagram 600 of a device 605 that supports techniques for multi-codeword communications using CDM group-based DMRS port mapping in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for multi-codeword communications using CDM group-based DMRS port mapping). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for multi-codeword communications using CDM group-based DMRS port mapping). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for multi-codeword communications using CDM group-based DMRS port mapping as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving, from a base station, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. The communications manager 620 may be configured as or otherwise support a means for receiving, from the base station, second control signaling that indicates an antenna port field value from the set of multiple antenna port field values. The communications manager 620 may be configured as or otherwise support a means for receiving, from the base station and based on the antenna port field value, a first DMRS including the first codeword, where the first DMRS is received via a first set of DMRS ports corresponding to the first CDM group in accordance with the first mapping. The communications manager 620 may be configured as or otherwise support a means for receiving, from the base station and based on the antenna port field value, a second DMRS including the second codeword, where the second DMRS is received via a second set of DMRS ports corresponding to the second CDM group in accordance with the second mapping.

By including or configuring the communications manager 620 in accordance with examples as described herein, the device 605 (e.g., a processor controlling or otherwise coupled to the receiver 610, the transmitter 615, the communications manager 620, or a combination thereof) may support techniques which enable mTRP communications using multiple codewords. In particular, the DMRS port mapping configurations described herein may map DMRS ports corresponding to respective CDM groups to individual codewords so that DMRSs for the respective codewords which are transmitted using different TRPs may be separable at the receiver device. Accordingly, by enabling mTRP DMRS transmissions associated with multiple codewords to be efficiently decoded at receiver devices, techniques described herein may facilitate mTRP channel estimation at the receiver device, which may facilitate more efficient and reliable wireless communications.

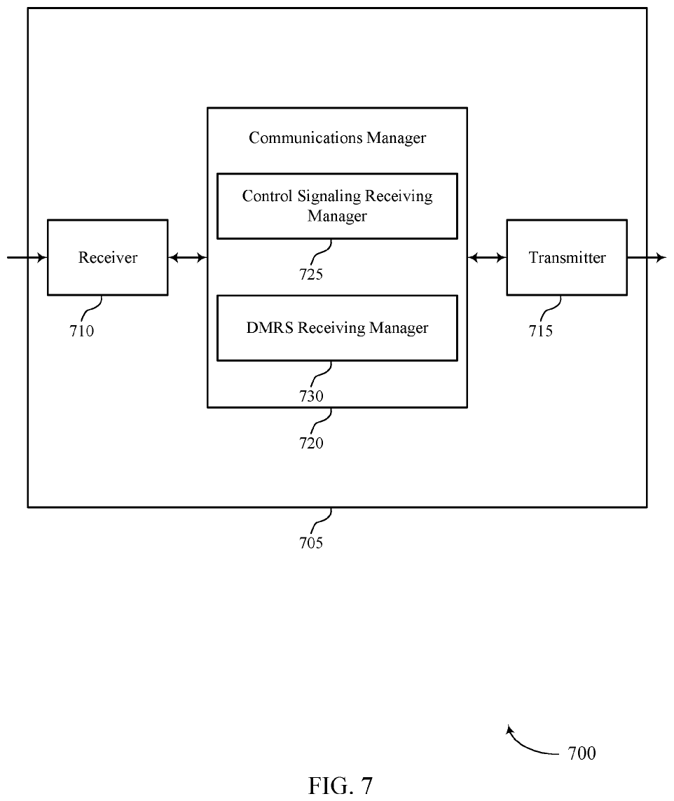

FIG. 7 shows a block diagram 700 of a device 705 that supports techniques for multi-codeword communications using CDM group-based DMRS port mapping in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for multi-codeword communications using CDM group-based DMRS port mapping). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for multi-codeword communications using CDM group-based DMRS port mapping). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for multi-codeword communications using CDM group-based DMRS port mapping as described herein. For example, the communications manager 720 may include a control signaling receiving manager 725 a DMRS receiving manager 730, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The control signaling receiving manager 725 may be configured as or otherwise support a means for receiving, from a base station, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. The control signaling receiving manager 725 may be configured as or otherwise support a means for receiving, from the base station, second control signaling that indicates an antenna port field value from the set of multiple antenna port field values. The DMRS receiving manager 730 may be configured as or otherwise support a means for receiving, from the base station and based on the antenna port field value, a first DMRS including the first codeword, where the first DMRS is received via a first set of DMRS ports corresponding to the first CDM group in accordance with the first mapping. The DMRS receiving manager 730 may be configured as or otherwise support a means for receiving, from the base station and based on the antenna port field value, a second DMRS including the second codeword, where the second DMRS is received via a second set of DMRS ports corresponding to the second CDM group in accordance with the second mapping.

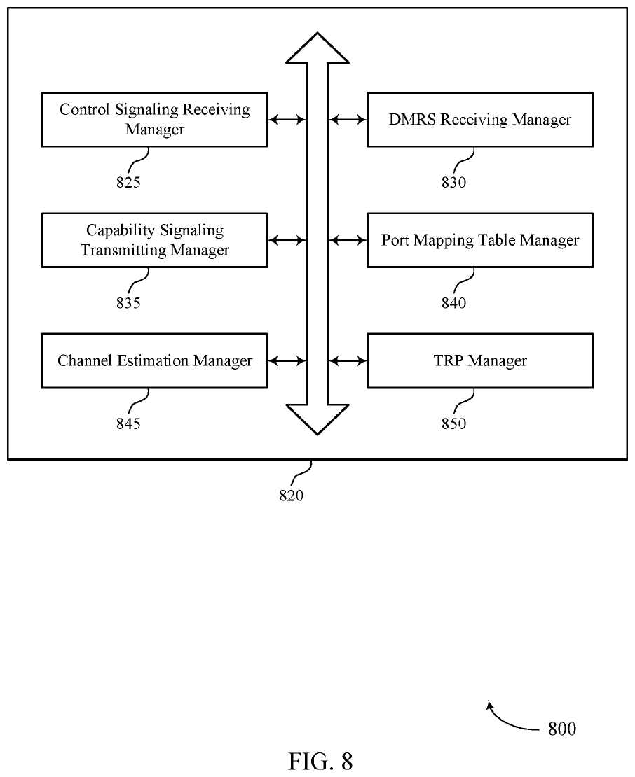

FIG. 8 shows a block diagram 800 of a communications manager 820 that supports techniques for multi-codeword communications using CDM group-based DMRS port mapping in accordance with aspects of the present disclosure. The communications manager 820 may be an example of aspects of a communications manager 620, a communications manager 720, or both, as described herein. The communications manager 820, or various components thereof, may be an example of means for performing various aspects of techniques for multi-codeword communications using CDM group-based DMRS port mapping as described herein. For example, the communications manager 820 may include a control signaling receiving manager 825, a DMRS receiving manager 830, a capability signaling transmitting manager 835, a port mapping table manager 840, a channel estimation manager 845, an TRP manager 850, or any combination thereof. Each of these components may communicate, directly or indirectly, with one another (e.g., via one or more buses).

The communications manager 820 may support wireless communication at a UE in accordance with examples as disclosed herein. The control signaling receiving manager 825 may be configured as or otherwise support a means for receiving, from a base station, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. In some examples, the control signaling receiving manager 825 may be configured as or otherwise support a means for receiving, from the base station, second control signaling that indicates an antenna port field value from the set of multiple antenna port field values. The DMRS receiving manager 830 may be configured as or otherwise support a means for receiving, from the base station and based on the antenna port field value, a first DMRS including the first codeword, where the first DMRS is received via a first set of DMRS ports corresponding to the first CDM group in accordance with the first mapping. In some examples, the DMRS receiving manager 830 may be configured as or otherwise support a means for receiving, from the base station and based on the antenna port field value, a second DMRS including the second codeword, where the second DMRS is received via a second set of DMRS ports corresponding to the second CDM group in accordance with the second mapping.

In some examples, the capability signaling transmitting manager 835 may be configured as or otherwise support a means for transmitting, to the base station, capability signaling indicating a capability of the UE to communicate with the base station in accordance with the DMRS port mapping configuration, where the first control signaling, the second control signaling, or both, are received based on the capability signaling.

In some examples, the capability signaling transmitting manager 835 may be configured as or otherwise support a means for transmitting, via the capability signaling, an indication of one or more frequency bands, one or more component carriers, or both, which are associated with the capability of the UE to communicate in accordance with the DMRS port mapping configuration, where the first DMRS, the second DMRS, or both, are received within the one or more frequency bands, the one or more component carriers, or both.

In some examples, the port mapping table manager 840 may be configured as or otherwise support a means for referencing one or more port mapping tables associated with the DMRS port mapping configuration based on the antenna port field value indicated via the second control signaling. In some examples, the port mapping table manager 840 may be configured as or otherwise support a means for identifying the first set of DMRS ports and the second set of DMRS ports based on referencing the one or more port mapping tables.

In some examples, the channel estimation manager 845 may be configured as or otherwise support a means for determining a first channel estimate associated with a first channel between the UE and the first TRP at the base station based on the first codeword and the first CDM group associated with the first DMRS. In some examples, the channel estimation manager 845 may be configured as or otherwise support a means for determining a second channel estimate associated with a second channel between the UE and the second TRP at the base station based on the second codeword and the second CDM group associated with the second DMRS.

In some examples, where the first TRP and the second TRP are spatially separated at the base station. In some examples, where the first TRP and the second TRP are co-located at the base station. In some examples, for each antenna port field value of the set of multiple antenna port field values, the DMRS port mapping configuration includes at least one mapping for each of the first and second codewords such that DMRS ports corresponding to the respective first and second CDM groups are associated with only one of the first or second codewords.

In some examples, for the first antenna port field value, the DMRS port mapping configuration includes a third mapping between a third CDM group and the first codeword, and the DMRS receiving manager 830 may be configured as or otherwise support a means for receiving the first DMRS including the first codeword via the first set of DMRS ports corresponding to the first CDM group and the third set of DMRS ports corresponding to the third CDM group in accordance with the first and third mappings, respectively.

In some examples, the control signaling receiving manager 825 may be configured as or otherwise support a means for receiving, via the second control signaling, an indication of a set of resources for receiving the first DMRS, the second DMRS, or both, where the first DMRS, the second DMRS, or both, are received within the set of resources.

In some examples, the first DMRS is associated with a first set of wireless communication layers for the first codeword. In some examples, the second DMRS is associated with a second set of wireless communication layers for the second codeword. In some examples, the first set of wireless communication layers are different from the second set of wireless communication layers. In some examples, the first control signaling includes a radio resource control message, a MAC-CE message, or both. In some examples, the second control signaling includes a DCI message.

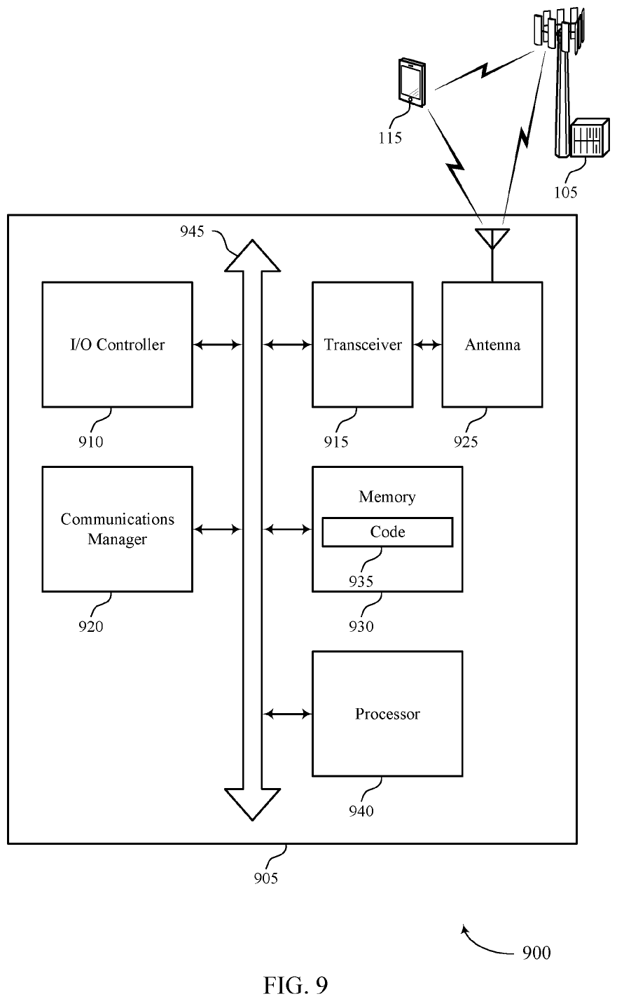

FIG. 9 shows a diagram of a system 900 including a device 905 that supports techniques for multi-codeword communications using CDM group-based DMRS port mapping in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for multi-codeword communications using CDM group-based DMRS port mapping). For example, the device 905 or a component of the device 905 may include a processor 940 and memory 930 coupled to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a base station, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. The communications manager 920 may be configured as or otherwise support a means for receiving, from the base station, second control signaling that indicates an antenna port field value from the set of multiple antenna port field values. The communications manager 920 may be configured as or otherwise support a means for receiving, from the base station and based on the antenna port field value, a first DMRS including the first codeword, where the first DMRS is received via a first set of DMRS ports corresponding to the first CDM group in accordance with the first mapping. The communications manager 920 may be configured as or otherwise support a means for receiving, from the base station and based on the antenna port field value, a second DMRS including the second codeword, where the second DMRS is received via a second set of DMRS ports corresponding to the second CDM group in accordance with the second mapping.

By including or configuring the communications manager 920 in accordance with examples as described herein, the device 905 may support techniques which enable mTRP communications using multiple codewords. In particular, the DMRS port mapping configurations described herein may map DMRS ports corresponding to respective CDM groups to individual codewords so that DMRSs for the respective codewords which are transmitted using different TRPs may be separable at the receiver device. Accordingly, by enabling mTRP DMRS transmissions associated with multiple codewords to be efficiently decoded at receiver devices, techniques described herein may facilitate mTRP channel estimation at the receiver device, which may facilitate more efficient and reliable wireless communications.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for multi-codeword communications using CDM group-based DMRS port mapping as described herein, or the processor 940 and the memory 930 may be otherwise configured to perform or support such operations.

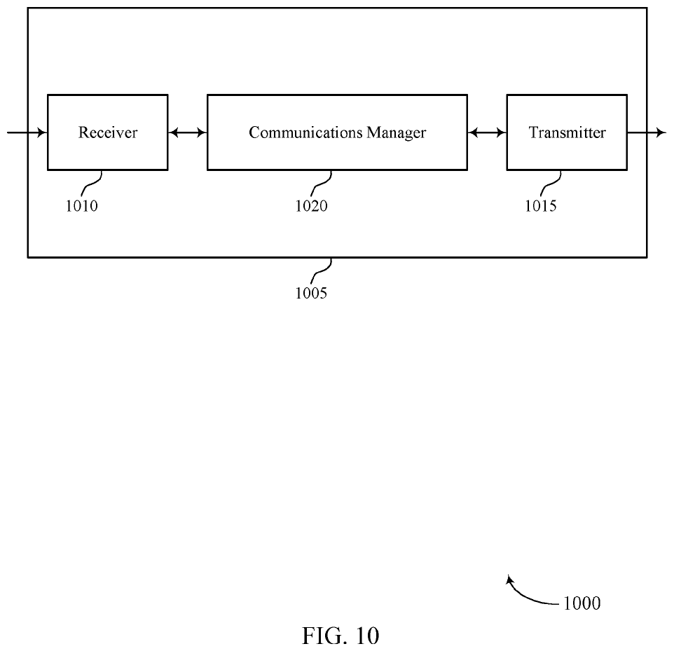

FIG. 10 shows a block diagram 1000 of a device 1005 that supports techniques for multi-codeword communications using CDM group-based DMRS port mapping in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for multi-codeword communications using CDM group-based DMRS port mapping). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for multi-codeword communications using CDM group-based DMRS port mapping). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of techniques for multi-codeword communications using CDM group-based DMRS port mapping as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. For example, the communications manager 1020 may be configured as or otherwise support a means for transmitting, to a UE, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. The communications manager 1020 may be configured as or otherwise support a means for transmitting, to the UE, second control signaling that indicates an antenna port field value from the set of multiple antenna port field values. The communications manager 1020 may be configured as or otherwise support a means for transmitting, to the UE and based on the antenna port field value, a first DMRS including the first codeword, where the first DMRS is transmitted via a first set of DMRS ports corresponding to the first CDM group in accordance with the first mapping. The communications manager 1020 may be configured as or otherwise support a means for transmitting, to the UE and based on the antenna port field value, a second DMRS including the second codeword, where the second DMRS is transmitted via a second set of DMRS ports corresponding to the second CDM group in accordance with the second mapping.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques which enable mTRP communications using multiple codewords. In particular, the DMRS port mapping configurations described herein may map DMRS ports corresponding to respective CDM groups to individual codewords so that DMRSs for the respective codewords which are transmitted using different TRPs may be separable at the receiver device. Accordingly, by enabling mTRP DMRS transmissions associated with multiple codewords to be efficiently decoded at receiver devices, techniques described herein may facilitate mTRP channel estimation at the receiver device, which may facilitate more efficient and reliable wireless communications.

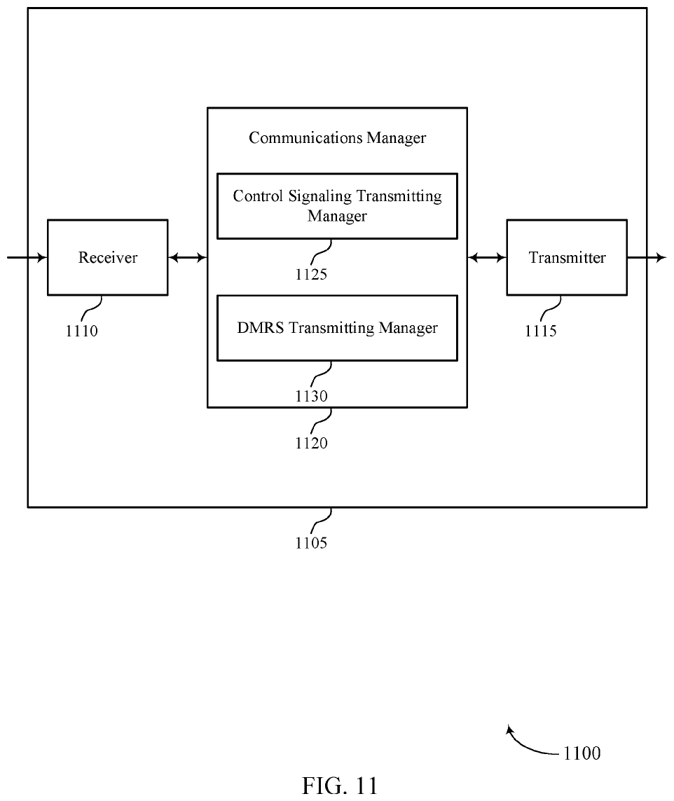

FIG. 11 shows a block diagram 1100 of a device 1105 that supports techniques for multi-codeword communications using CDM group-based DMRS port mapping in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for multi-codeword communications using CDM group-based DMRS port mapping). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for multi-codeword communications using CDM group-based DMRS port mapping). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of techniques for multi-codeword communications using CDM group-based DMRS port mapping as described herein. For example, the communications manager 1120 may include a control signaling transmitting manager 1125 a DMRS transmitting manager 1130, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. The control signaling transmitting manager 1125 may be configured as or otherwise support a means for transmitting, to a UE, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. The control signaling transmitting manager 1125 may be configured as or otherwise support a means for transmitting, to the UE, second control signaling that indicates an antenna port field value from the set of multiple antenna port field values. The DMRS transmitting manager 1130 may be configured as or otherwise support a means for transmitting, to the UE and based on the antenna port field value, a first DMRS including the first codeword, where the first DMRS is transmitted via a first set of DMRS ports corresponding to the first CDM group in accordance with the first mapping. The DMRS transmitting manager 1130 may be configured as or otherwise support a means for transmitting, to the UE and based on the antenna port field value, a second DMRS including the second codeword, where the second DMRS is transmitted via a second set of DMRS ports corresponding to the second CDM group in accordance with the second mapping.

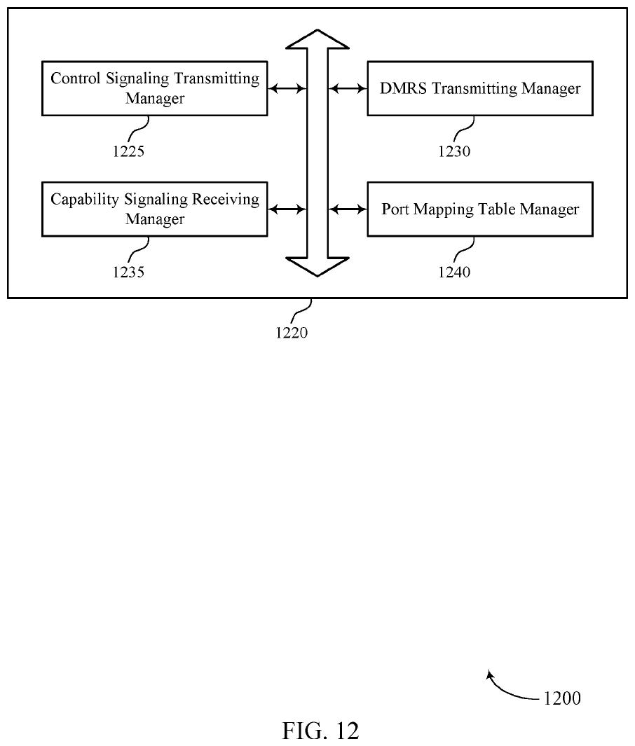

FIG. 12 shows a block diagram 1200 of a communications manager 1220 that supports techniques for multi-codeword communications using CDM group-based DMRS port mapping in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of techniques for multi-codeword communications using CDM group-based DMRS port mapping as described herein. For example, the communications manager 1220 may include a control signaling transmitting manager 1225, a DMRS transmitting manager 1230, a capability signaling receiving manager 1235, a port mapping table manager 1240, or any combination thereof. Each of these components may communicate, directly or indirectly, with one another (e.g., via one or more buses).

The communications manager 1220 may support wireless communication at a base station in accordance with examples as disclosed herein. The control signaling transmitting manager 1225 may be configured as or otherwise support a means for transmitting, to a UE, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. In some examples, the control signaling transmitting manager 1225 may be configured as or otherwise support a means for transmitting, to the UE, second control signaling that indicates an antenna port field value from the set of multiple antenna port field values. The DMRS transmitting manager 1230 may be configured as or otherwise support a means for transmitting, to the UE and based on the antenna port field value, a first DMRS including the first codeword, where the first DMRS is transmitted via a first set of DMRS ports corresponding to the first CDM group in accordance with the first mapping. In some examples, the DMRS transmitting manager 1230 may be configured as or otherwise support a means for transmitting, to the UE and based on the antenna port field value, a second DMRS including the second codeword, where the second DMRS is transmitted via a second set of DMRS ports corresponding to the second CDM group in accordance with the second mapping.

In some examples, the capability signaling receiving manager 1235 may be configured as or otherwise support a means for receiving, from the UE, capability signaling indicating a capability of the UE to communicate with the base station in accordance with the DMRS port mapping configuration, where the first control signaling, the second control signaling, or both, are transmitted based on the capability signaling.

In some examples, the capability signaling receiving manager 1235 may be configured as or otherwise support a means for receiving, via the capability signaling, an indication of one or more frequency bands, one or more component carriers, or both, which are associated with the capability of the UE to communicate in accordance with the DMRS port mapping configuration, where the first DMRS, the second DMRS, or both, are transmitted within the one or more frequency bands, the one or more component carriers, or both.

In some examples, the port mapping table manager 1240 may be configured as or otherwise support a means for referencing one or more port mapping tables associated with the DMRS port mapping configuration based on the antenna port field value. In some examples, the port mapping table manager 1240 may be configured as or otherwise support a means for identifying the first set of DMRS ports and the second set of DMRS ports based on referencing the one or more port mapping tables.

In some examples, where the first TRP and the second TRP are spatially separated at the base station. In some examples, where the first TRP and the second TRP are co-located at the base station. In some examples, for each antenna port field value of the set of multiple antenna port field values, the DMRS port mapping configuration includes at least one mapping for each of the first and second codewords such that DMRS ports corresponding to the respective first and second CDM groups are associated with only one of the first or second codewords.

In some examples, for the first antenna port field value, the DMRS port mapping configuration includes a third mapping between a third CDM group and the first codeword, and the DMRS transmitting manager 1230 may be configured as or otherwise support a means for transmitting the first DMRS including the first codeword via the first set of DMRS ports corresponding to the first CDM group and the third set of DMRS ports corresponding to the third CDM group in accordance with the first and third mappings, respectively.

In some examples, the control signaling transmitting manager 1225 may be configured as or otherwise support a means for transmitting, via the second control signaling, an indication of a set of resources for receiving the first DMRS, the second DMRS, or both, where the first DMRS, the second DMRS, or both, are transmitted within the set of resources.

In some examples, the first DMRS is associated with a first set of wireless communication layers for the first codeword. In some examples, the second DMRS is associated with a second set of wireless communication layers for the second codeword. In some examples, the first set of wireless communication layers are different from the second set of wireless communication layers. In some examples, the first control signaling includes a radio resource control message, a MAC-CE message, or both. In some examples, the second control signaling includes a DCI message.

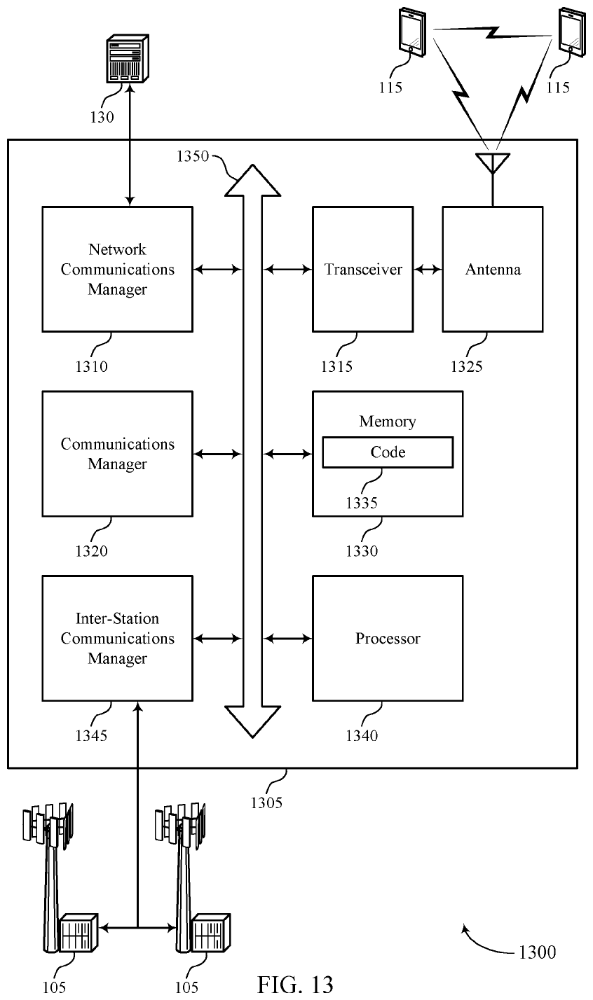

FIG. 13 shows a diagram of a system 1300 including a device 1305 that supports techniques for multi-codeword communications using CDM group-based DMRS port mapping in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for multi-codeword communications using CDM group-based DMRS port mapping). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a base station in accordance with examples as disclosed herein. For example, the communications manager 1320 may be configured as or otherwise support a means for transmitting, to a UE, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. The communications manager 1320 may be configured as or otherwise support a means for transmitting, to the UE, second control signaling that indicates an antenna port field value from the set of multiple antenna port field values. The communications manager 1320 may be configured as or otherwise support a means for transmitting, to the UE and based on the antenna port field value, a first DMRS including the first codeword, where the first DMRS is transmitted via a first set of DMRS ports corresponding to the first CDM group in accordance with the first mapping. The communications manager 1320 may be configured as or otherwise support a means for transmitting, to the UE and based on the antenna port field value, a second DMRS including the second codeword, where the second DMRS is transmitted via a second set of DMRS ports corresponding to the second CDM group in accordance with the second mapping.

By including or configuring the communications manager 1320 in accordance with examples as described herein, the device 1305 may support techniques which enable mTRP communications using multiple codewords. In particular, the DMRS port mapping configurations described herein may map DMRS ports corresponding to respective CDM groups to individual codewords so that DMRSs for the respective codewords which are transmitted using different TRPs may be separable at the receiver device. Accordingly, by enabling mTRP DMRS transmissions associated with multiple codewords to be efficiently decoded at receiver devices, techniques described herein may facilitate mTRP channel estimation at the receiver device, which may facilitate more efficient and reliable wireless communications.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for multi-codeword communications using CDM group-based DMRS port mapping as described herein, or the processor 1340 and the memory 1330 may be otherwise configured to perform or support such operations.

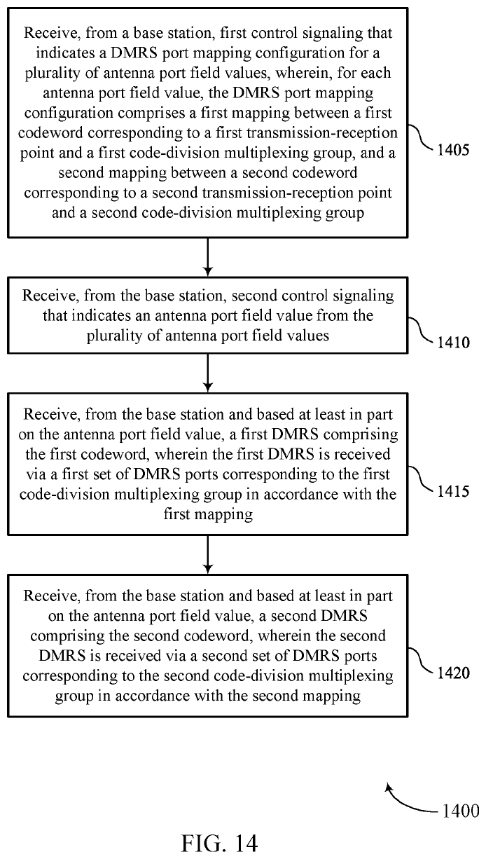

FIG. 14 shows a flowchart illustrating a method 1400 that supports techniques for multi-codeword communications using CDM group-based DMRS port mapping in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a base station, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. The operations of 1405 may be performed in accordance with examples as disclosed herein. In some examples, aspects of the operations of 1405 may be performed by a control signaling receiving manager 825 as described with reference to FIG. 8.

At 1410, the method may include receiving, from the base station, second control signaling that indicates an antenna port field value from the set of multiple antenna port field values. The operations of 1410 may be performed in accordance with examples as disclosed herein. In some examples, aspects of the operations of 1410 may be performed by a control signaling receiving manager 825 as described with reference to FIG. 8.

At 1415, the method may include receiving, from the base station and based on the antenna port field value, a first DMRS including the first codeword, where the first DMRS is received via a first set of DMRS ports corresponding to the first CDM group in accordance with the first mapping. The operations of 1415 may be performed in accordance with examples as disclosed herein. In some examples, aspects of the operations of 1415 may be performed by a DMRS receiving manager 830 as described with reference to FIG. 8.

At 1420, the method may include receiving, from the base station and based on the antenna port field value, a second DMRS including the second codeword, where the second DMRS is received via a second set of DMRS ports corresponding to the second CDM group in accordance with the second mapping. The operations of 1420 may be performed in accordance with examples as disclosed herein. In some examples, aspects of the operations of 1420 may be performed by a DMRS receiving manager 830 as described with reference to FIG. 8.

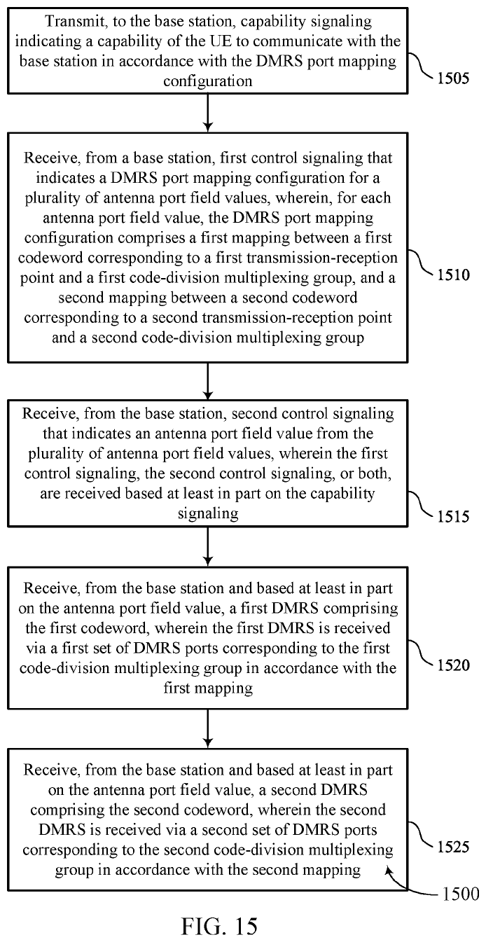

FIG. 15 shows a flowchart illustrating a method 1500 that supports techniques for multi-codeword communications using CDM group-based DMRS port mapping in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting, to the base station, capability signaling indicating a capability of the UE to communicate with the base station in accordance with the DMRS port mapping configuration. The operations of 1505 may be performed in accordance with examples as disclosed herein. In some examples, aspects of the operations of 1505 may be performed by a capability signaling transmitting manager 835 as described with reference to FIG. 8.

At 1510, the method may include receiving, from a base station, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. The operations of 1510 may be performed in accordance with examples as disclosed herein. In some examples, aspects of the operations of 1510 may be performed by a control signaling receiving manager 825 as described with reference to FIG. 8.

At 1515, the method may include receiving, from the base station, second control signaling that indicates an antenna port field value from the set of multiple antenna port field values, where the first control signaling, the second control signaling, or both, are received based on the capability signaling. The operations of 1515 may be performed in accordance with examples as disclosed herein. In some examples, aspects of the operations of 1515 may be performed by a control signaling receiving manager 825 as described with reference to FIG. 8.

At 1520, the method may include receiving, from the base station and based on the antenna port field value, a first DMRS including the first codeword, where the first DMRS is received via a first set of DMRS ports corresponding to the first CDM group in accordance with the first mapping. The operations of 1520 may be performed in accordance with examples as disclosed herein. In some examples, aspects of the operations of 1520 may be performed by a DMRS receiving manager 830 as described with reference to FIG. 8.

At 1525, the method may include receiving, from the base station and based on the antenna port field value, a second DMRS including the second codeword, where the second DMRS is received via a second set of DMRS ports corresponding to the second CDM group in accordance with the second mapping. The operations of 1525 may be performed in accordance with examples as disclosed herein. In some examples, aspects of the operations of 1525 may be performed by a DMRS receiving manager 830 as described with reference to FIG. 8.

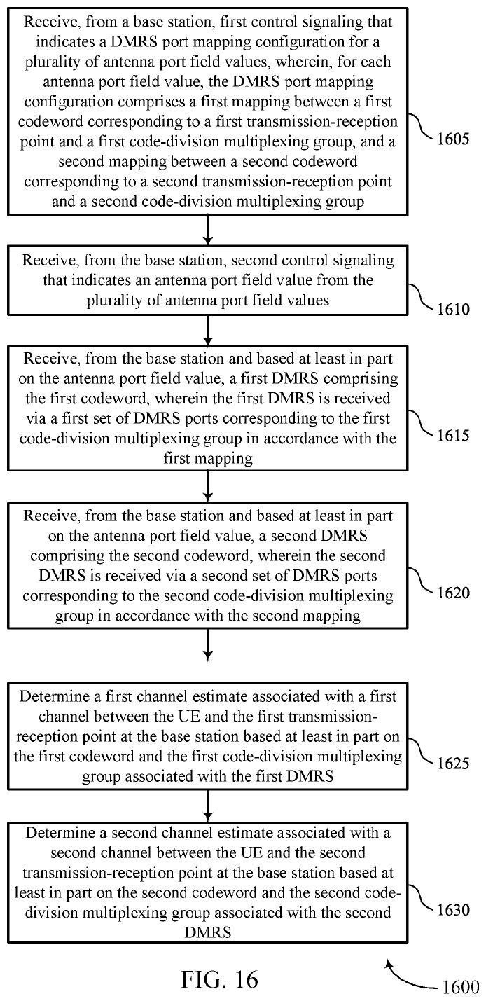

FIG. 16 shows a flowchart illustrating a method 1600 that supports techniques for multi-codeword communications using CDM group-based DMRS port mapping in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, from a base station, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. The operations of 1605 may be performed in accordance with examples as disclosed herein. In some examples, aspects of the operations of 1605 may be performed by a control signaling receiving manager 825 as described with reference to FIG. 8.

At 1610, the method may include receiving, from the base station, second control signaling that indicates an antenna port field value from the set of multiple antenna port field values. The operations of 1610 may be performed in accordance with examples as disclosed herein. In some examples, aspects of the operations of 1610 may be performed by a control signaling receiving manager 825 as described with reference to FIG. 8.

At 1615, the method may include receiving, from the base station and based on the antenna port field value, a first DMRS including the first codeword, where the first DMRS is received via a first set of DMRS ports corresponding to the first CDM group in accordance with the first mapping. The operations of 1615 may be performed in accordance with examples as disclosed herein. In some examples, aspects of the operations of 1615 may be performed by a DMRS receiving manager 830 as described with reference to FIG. 8.

At 1620, the method may include receiving, from the base station and based on the antenna port field value, a second DMRS including the second codeword, where the second DMRS is received via a second set of DMRS ports corresponding to the second CDM group in accordance with the second mapping. The operations of 1620 may be performed in accordance with examples as disclosed herein. In some examples, aspects of the operations of 1620 may be performed by a DMRS receiving manager 830 as described with reference to FIG. 8.

At 1625, the method may include determining a first channel estimate associated with a first channel between the UE and the first TRP at the base station based on the first codeword and the first CDM group associated with the first DMRS. The operations of 1625 may be performed in accordance with examples as disclosed herein. In some examples, aspects of the operations of 1625 may be performed by a channel estimation manager 845 as described with reference to FIG. 8.

At 1630, the method may include determining a second channel estimate associated with a second channel between the UE and the second TRP at the base station based on the second codeword and the second CDM group associated with the second DMRS. The operations of 1630 may be performed in accordance with examples as disclosed herein. In some examples, aspects of the operations of 1630 may be performed by a channel estimation manager 845 as described with reference to FIG. 8.

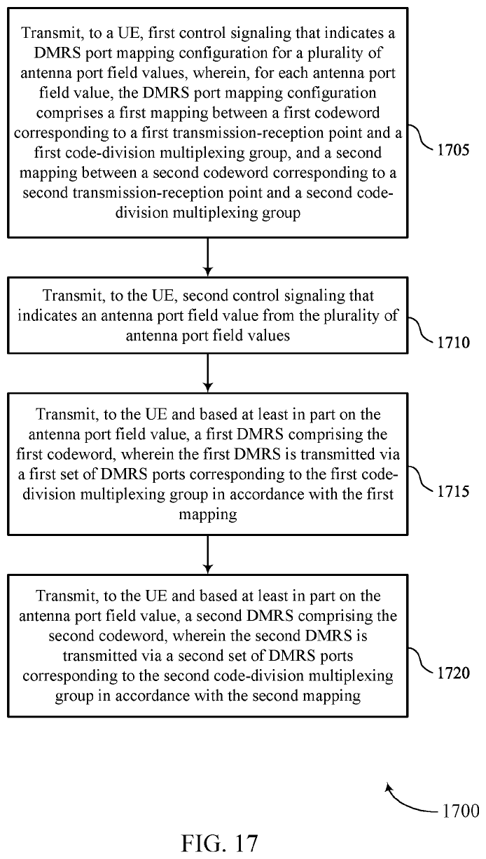

FIG. 17 shows a flowchart illustrating a method 1700 that supports techniques for multi-codeword communications using CDM group-based DMRS port mapping in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally, or alternatively, the base station may perform aspects of the described functions using special-purpose hardware.

At 1705, the method may include transmitting, to a UE, first control signaling that indicates a DMRS port mapping configuration for a set of multiple antenna port field values, where, for each antenna port field value, the DMRS port mapping configuration includes a first mapping between a first codeword corresponding to a first TRP and a first CDM group, and a second mapping between a second codeword corresponding to a second TRP and a second CDM group. The operations of 1705 may be performed in accordance with examples as disclosed herein. In some examples, aspects of the operations of 1705 may be performed by a control signaling transmitting manager 1225 as described with reference to FIG. 12.

At 1710, the method may include transmitting, to the UE, second control signaling that indicates an antenna port field value from the set of multiple antenna port field values. The operations of 1710 may be performed in accordance with examples as disclosed herein. In some examples, aspects of the operations of 1710 may be performed by a control signaling transmitting manager 1225 as described with reference to FIG. 12.

At 1715, the method may include transmitting, to the UE and based on the antenna port field value, a first DMRS including the first codeword, where the first DMRS is transmitted via a first set of DMRS ports corresponding to the first CDM group in accordance with the first mapping. The operations of 1715 may be performed in accordance with examples as disclosed herein. In some examples, aspects of the operations of 1715 may be performed by a DMRS transmitting manager 1230 as described with reference to FIG. 12.

At 1720, the method may include transmitting, to the UE and based on the antenna port field value, a second DMRS including the second codeword, where the second DMRS is transmitted via a second set of DMRS ports corresponding to the second CDM group in accordance with the second mapping. The operations of 1720 may be performed in accordance with examples as disclosed herein. In some examples, aspects of the operations of 1720 may be performed by a DMRS transmitting manager 1230 as described with reference to FIG. 12.

The following provides an overview of aspects of the present disclosure:

Aspect 1: A method for wireless communication at a UE, comprising: receiving, from a base station, first control signaling that indicates a DMRS port mapping configuration for a plurality of antenna port field values, wherein, for each antenna port field value, the DMRS port mapping configuration comprises a first mapping between a first codeword corresponding to a first TRP and a first CDM group, and a second mapping between a second codeword corresponding to a second TRP and a second CDM group; receiving, from the base station, second control signaling that indicates an antenna port field value from the plurality of antenna port field values; receiving, from the base station and based at least in part on the antenna port field value, a first DMRS comprising the first codeword, wherein the first DMRS is received via a first set of DMRS ports corresponding to the first CDM group in accordance with the first mapping; and receiving, from the base station and based at least in part on the antenna port field value, a second DMRS comprising the second codeword, wherein the second DMRS is received via a second set of DMRS ports corresponding to the second CDM group in accordance with the second mapping.

Aspect 2: The method of aspect 1, further comprising: transmitting, to the base station, capability signaling indicating a capability of the UE to communicate with the base station in accordance with the DMRS port mapping configuration, wherein the first control signaling, the second control signaling, or both, are received based at least in part on the capability signaling.

Aspect 3: The method of aspect 2, further comprising: transmitting, via the capability signaling, an indication of one or more frequency bands, one or more component carriers, or both, which are associated with the capability of the UE to communicate in accordance with the DMRS port mapping configuration, wherein the first DMRS, the second DMRS, or both, are received within the one or more frequency bands, the one or more component carriers, or both.

Aspect 4: The method of any of aspects 1 through 3, further comprising: referencing one or more port mapping tables associated with the DMRS port mapping configuration based at least in part on the antenna port field value indicated via the second control signaling; and identifying the first set of DMRS ports and the second set of DMRS ports based at least in part on referencing the one or more port mapping tables.

Aspect 5: The method of any of aspects 1 through 4, further comprising: determining a first channel estimate associated with a first channel between the UE and the first TRP at the base station based at least in part on the first codeword and the first CDM group associated with the first DMRS; and determining a second channel estimate associated with a second channel between the UE and the second TRP at the base station based at least in part on the second codeword and the second CDM group associated with the second DMRS.

Aspect 6: The method of aspect 5, wherein the first TRP and the second TRP are spatially separated at the base station, or wherein the first TRP and the second TRP are co-located at the base station

Aspect 7: The method of any of aspects 1 through 6, wherein for each antenna port field value of the plurality of antenna port field values, the DMRS port mapping configuration includes at least one mapping for each of the first and second codewords such that DMRS ports corresponding to the respective first and second CDM groups are associated with only one of the first or second codewords.

Aspect 8: The method of any of aspects 1 through 7, wherein, for the antenna port field value, the DMRS port mapping configuration comprises a third mapping between a third CDM group and the first codeword, the method further comprising: receiving the first DMRS comprising the first codeword via the first set of DMRS ports corresponding to the first CDM group and the third set of DMRS ports corresponding to the third CDM group in accordance with the first and third mappings, respectively.

Aspect 9: The method of any of aspects 1 through 8, further comprising: receiving, via the second control signaling, an indication of a set of resources for receiving the first DMRS, the second DMRS, or both, wherein the first DMRS, the second DMRS, or both, are received within the set of resources.

Aspect 10: The method of any of aspects 1 through 9, wherein the first DMRS is associated with a first set of wireless communication layers for the first codeword, and the second DMRS is associated with a second set of wireless communication layers for the second codeword, the first set of wireless communication layers are different from the second set of wireless communication layers.

Aspect 11: The method of any of aspects 1 through 10, wherein the first control signaling comprises a RRC message, a MAC-CE message, or both, and the second control signaling comprises a DCI message.

Aspect 12: A method for wireless communication at a base station, comprising: transmitting, to a UE, first control signaling that indicates a DMRS port mapping configuration for a plurality of antenna port field values, wherein, for each antenna port field value, the DMRS port mapping configuration comprises a first mapping between a first codeword corresponding to a first TRP and a first CDM group, and a second mapping between a second codeword corresponding to a second TRP and a second CDM group; transmitting, to the UE, second control signaling that indicates an antenna port field value from the plurality of antenna port field values; transmitting, to the UE and based at least in part on the antenna port field value, a first DMRS comprising the first codeword, wherein the first DMRS is transmitted via a first set of DMRS ports corresponding to the first CDM group in accordance with the first mapping; and transmitting, to the UE and based at least in part on the antenna port field value, a second DMRS comprising the second codeword, wherein the second DMRS is transmitted via a second set of DMRS ports corresponding to the second CDM group in accordance with the second mapping.

Aspect 13: The method of aspect 12, further comprising: receiving, from the UE, capability signaling indicating a capability of the UE to communicate with the base station in accordance with the DMRS port mapping configuration, wherein the first control signaling, the second control signaling, or both, are transmitted based at least in part on the capability signaling.

Aspect 14: The method of aspect 13, further comprising: receiving, via the capability signaling, an indication of one or more frequency bands, one or more component carriers, or both, which are associated with the capability of the UE to communicate in accordance with the DMRS port mapping configuration, wherein the first DMRS, the second DMRS, or both, are transmitted within the one or more frequency bands, the one or more component carriers, or both.

Aspect 15: The method of any of aspects 12 through 14, further comprising: referencing one or more port mapping tables associated with the DMRS port mapping configuration based at least in part on the antenna port field value; and identifying the first set of DMRS ports and the second set of DMRS ports based at least in part on referencing the one or more port mapping tables.

Aspect 16: The method of any of aspects 12 through 15, wherein the first TRP and the second TRP are spatially separated at the base station, or wherein the first TRP and the second TRP are co-located at the base station

Aspect 17: The method of any of aspects 12 through 16, wherein for each antenna port field value of the plurality of antenna port field values, the DMRS port mapping configuration includes at least one mapping for each of the first and second codewords such that DMRS ports corresponding to the respective first and second CDM groups are associated with only one of the first or second codewords.

Aspect 18: The method of any of aspects 12 through 17, wherein, for the antenna port field value, the DMRS port mapping configuration comprises a third mapping between the first codeword and a third set of DMRSW ports corresponding to a third CDM group, the method further comprising: transmitting the first DMRS comprising the first codeword via the first set of DMRS ports corresponding to the first CDM group and the third set of DMRS ports corresponding to the third CDM group in accordance with the first and third mappings, respectively.

Aspect 19: The method of any of aspects 12 through 18, further comprising: transmitting, via the second control signaling, an indication of a set of resources for receiving the first DMRS, the second DMRS, or both, wherein the first DMRS, the second DMRS, or both, are transmitted within the set of resources.

Aspect 20: The method of any of aspects 12 through 19, wherein the first DMRS is associated with a first set of wireless communication layers for the first codeword, and the second DMRS is associated with a second set of wireless communication layers for the second codeword, the first set of wireless communication layers are different from the second set of wireless communication layers.

Aspect 21: The method of any of aspects 12 through 20, wherein the first control signaling comprises a RRC message, a MAC-CE message, or both, and the second control signaling comprises a DCI message.

Aspect 22: An apparatus for wireless communication at a UE, comprising a processor; memory coupled with the processor; and instructions stored in the memory and executable by the processor to cause the apparatus to perform a method of any of aspects 1 through 11.

Aspect 23: An apparatus for wireless communication at a UE, comprising at least one means for performing a method of any of aspects 1 through 11.

Aspect 24: A non-transitory computer-readable medium storing code for wireless communication at a UE, the code comprising instructions executable by a processor to perform a method of any of aspects 1 through 11.

Aspect 25: An apparatus for wireless communication at a base station, comprising a processor; memory coupled with the processor; and instructions stored in the memory and executable by the processor to cause the apparatus to perform a method of any of aspects 12 through 21.

Aspect 26: An apparatus for wireless communication at a base station, comprising at least one means for performing a method of any of aspects 12 through 21.

Aspect 27: A non-transitory computer-readable medium storing code for wireless communication at a base station, the code comprising instructions executable by a processor to perform a method of any of aspects 12 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, first control signaling that indicates a demodulation reference signal (DMRS) port mapping configuration for a plurality of antenna port field values, wherein, for each antenna port field value, the DMRS port mapping configuration comprises a first mapping between a first codeword corresponding to a first transmission-reception point and a first code-division multiplexing group, and a second mapping between a second codeword corresponding to a second transmission-reception point and a second code-division multiplexing group;
receiving, from the base station, second control signaling that indicates an antenna port field value from the plurality of antenna port field values;
receiving, from the base station and based at least in part on the antenna port field value, a first DMRS comprising the first codeword, wherein the first DMRS is received via a first set of DMRS ports corresponding to the first code-division multiplexing group in accordance with the first mapping; and
receiving, from the base station and based at least in part on the antenna port field value, a second DMRS comprising the second codeword, wherein the second DMRS is received via a second set of DMRS ports corresponding to the second code-division multiplexing group in accordance with the second mapping.

2. The method of claim 1, further comprising:
transmitting, to the base station, capability signaling indicating a capability of the UE to communicate with the base station in accordance with the DMRS port mapping configuration, wherein the first control signaling, the second control signaling, or both, are received based at least in part on the capability signaling.

3. The method of claim 2, further comprising:
transmitting, via the capability signaling, an indication of one or more frequency bands, one or more component carriers, or both, which are associated with the capability of the UE to communicate in accordance with the DMRS port mapping configuration, wherein the first DMRS, the second DMRS, or both, are received within the one or more frequency bands, the one or more component carriers, or both.

4. The method of claim 1, further comprising:
referencing one or more port mapping tables associated with the DMRS port mapping configuration based at least in part on the antenna port field value indicated via the second control signaling; and
identifying the first set of DMRS ports and the second set of DMRS ports based at least in part on referencing the one or more port mapping tables.

5. The method of claim 1, further comprising:
determining a first channel estimate associated with a first channel between the UE and the first transmission-reception point at the base station based at least in part on the first codeword and the first code-division multiplexing group associated with the first DMRS; and
determining a second channel estimate associated with a second channel between the UE and the second transmission-reception point at the base station based at least in part on the second codeword and the second code-division multiplexing group associated with the second DMRS.

6. The method of claim 5,
wherein the first transmission-reception point and the second transmission-reception point are spatially separated at the base station, or
wherein the first transmission-reception point and the second transmission-reception point are co-located at the base station.

7. The method of claim 1, wherein for each antenna port field value of the plurality of antenna port field values, the DMRS port mapping configuration includes at least one mapping for each of the first and second codewords such that DMRS ports corresponding to the respective first and second code-division multiplexing groups are associated with only one of the first or second codewords.

8. The method of claim 1, wherein, for the antenna port field value, the DMRS port mapping configuration comprises a third mapping between a third code-division multiplexing group and the first codeword, the method further comprising:
receiving the first DMRS comprising the first codeword via the first set of DMRS ports corresponding to the first code-division multiplexing group and the third set of DMRS ports corresponding to the third code-division multiplexing group in accordance with the first and third mappings, respectively.

9. The method of claim 1, further comprising:
receiving, via the second control signaling, an indication of a set of resources for receiving the first DMRS, the second DMRS, or both, wherein the first DMRS, the second DMRS, or both, are received within the set of resources.

10. The method of claim 1, wherein the first DMRS is associated with a first set of wireless communication layers for the first codeword, and wherein the second DMRS is associated with a second set of wireless communication layers for the second codeword, wherein the first set of wireless communication layers are different from the second set of wireless communication layers.

11. The method of claim 1, wherein the first control signaling comprises a radio resource control message, a medium access control-control element message, or both, and wherein the second control signaling comprises a downlink control information message.

12. A method for wireless communication at a base station, comprising:
transmitting, to a user equipment (UE), first control signaling that indicates a demodulation reference signal (DMRS) port mapping configuration for a plurality of antenna port field values, wherein, for each antenna port field value, the DMRS port mapping configuration comprises a first mapping between a first codeword corresponding to a first transmission-reception point and a first code-division multiplexing group, and a second mapping between a second codeword corresponding to a second transmission-reception point and a second code-division multiplexing group;
transmitting, to the UE, second control signaling that indicates an antenna port field value from the plurality of antenna port field values;
transmitting, to the UE and based at least in part on the antenna port field value, a first DMRS comprising the first codeword, wherein the first DMRS is transmitted via a first set of DMRS ports corresponding to the first code-division multiplexing group in accordance with the first mapping; and
transmitting, to the UE and based at least in part on the antenna port field value, a second DMRS comprising the second codeword, wherein the second DMRS is transmitted via a second set of DMRS ports corresponding to the second code-division multiplexing group in accordance with the second mapping.

13. The method of claim 12, further comprising:
receiving, from the UE, capability signaling indicating a capability of the UE to communicate with the base station in accordance with the DMRS port mapping configuration, wherein the first control signaling, the second control signaling, or both, are transmitted based at least in part on the capability signaling.

14. The method of claim 13, further comprising:
receiving, via the capability signaling, an indication of one or more frequency bands, one or more component carriers, or both, which are associated with the capability of the UE to communicate in accordance with the DMRS port mapping configuration, wherein the first DMRS, the second DMRS, or both, are transmitted within the one or more frequency bands, the one or more component carriers, or both.

15. The method of claim 12, further comprising:
referencing one or more port mapping tables associated with the DMRS port mapping configuration based at least in part on the antenna port field value; and
identifying the first set of DMRS ports and the second set of DMRS ports based at least in part on referencing the one or more port mapping tables.

16. The method of claim 12,
wherein the first transmission-reception point and the second transmission-reception point are spatially separated at the base station, or
wherein the first transmission-reception point and the second transmission-reception point are co-located at the base station.

17. The method of claim 12, wherein, for each antenna port field value of the plurality of antenna port field values, the DMRS port mapping configuration includes at least one mapping for each of the first and second codewords such that DMRS ports corresponding to the respective first and second code-division multiplexing groups are associated with only one of the first or second codewords.

18. The method of claim 12, wherein, for the antenna port field value, the DMRS port mapping configuration comprises a third mapping between the first codeword and a third set of DMRS ports corresponding to a third code-division multiplexing group, the method further comprising:
transmitting the first DMRS comprising the first codeword via the first set of DMRS ports corresponding to the first code-division multiplexing group and the third set of DMRS ports corresponding to the third code-division multiplexing group in accordance with the first and third mappings, respectively.

19. The method of claim 12, further comprising:
transmitting, via the second control signaling, an indication of a set of resources for receiving the first DMRS, the second DMRS, or both, wherein the first DMRS, the second DMRS, or both, are transmitted within the set of resources.

20. The method of claim 12, wherein the first DMRS is associated with a first set of wireless communication layers for the first codeword, and wherein the second DMRS is associated with a second set of wireless communication layers for the second codeword, wherein the first set of wireless communication layers are different from the second set of wireless communication layers.

21. The method of claim 12, wherein the first control signaling comprises a radio resource control message, a medium access control-control element message, or both, and wherein the second control signaling comprises a downlink control information message.

22. An apparatus for wireless communication at a user equipment (UE), comprising:
a processor;
memory coupled with the processor; and
instructions stored in the memory and executable by the processor to cause the apparatus to:
receive, from a base station, first control signaling that indicates a demodulation reference signal (DMRS) port mapping configuration for a plurality of antenna port field values, wherein, for each antenna port field value, the DMRS port mapping configuration comprises a first mapping between a first codeword corresponding to a first transmission-reception point and a first code-division multiplexing group, and a second mapping between a second codeword corresponding to a second transmission-reception point and a second code-division multiplexing group;
receive, from the base station, second control signaling that indicates an antenna port field value from the plurality of antenna port field values;
receive, from the base station and based at least in part on the antenna port field value, a first DMRS comprising the first codeword, wherein the first DMRS is received via a first set of DMRS ports corresponding to the first code-division multiplexing group in accordance with the first mapping; and
receive, from the base station and based at least in part on the antenna port field value, a second DMRS comprising the second codeword, wherein the second DMRS is received via a second set of DMRS ports corresponding to the second code-division multiplexing group in accordance with the second mapping.

23. The apparatus of claim 22, wherein the instructions are further executable by the processor to cause the apparatus to:
transmit, to the base station, capability signaling indicating a capability of the UE to communicate with the base station in accordance with the DMRS port mapping configuration, wherein the first control signaling, the second control signaling, or both, are received based at least in part on the capability signaling.

24. The apparatus of claim 23, wherein the instructions are further executable by the processor to cause the apparatus to:
transmit, via the capability signaling, an indication of one or more frequency bands, one or more component carriers, or both, which are associated with the capability of the UE to communicate in accordance with the DMRS port mapping configuration, wherein the first DMRS, the second DMRS, or both, are received within the one or more frequency bands, the one or more component carriers, or both.

25. The apparatus of claim 22, wherein the instructions are further executable by the processor to cause the apparatus to:
reference one or more port mapping tables associated with the DMRS port mapping configuration based at least in part on the antenna port field value indicated via the second control signaling; and
identify the first set of DMRS ports and the second set of DMRS ports based at least in part on referencing the one or more port mapping tables.

26. The apparatus of claim 22, wherein the instructions are further executable by the processor to cause the apparatus to:
determine a first channel estimate associated with a first channel between the UE and the first transmission-reception point at the base station based at least in part on the first codeword and the first code-division multiplexing group associated with the first DMRS; and
determine a second channel estimate associated with a second channel between the UE and the second transmission-reception point at the base station based at least in part on the second codeword and the second code-division multiplexing group associated with the second DMRS.

27. An apparatus for wireless communication at a base station, comprising:
a processor;
memory coupled with the processor; and
instructions stored in the memory and executable by the processor to cause the apparatus to:
transmit, to a user equipment (UE), first control signaling that indicates a demodulation reference signal (DMRS) port mapping configuration for a plurality of antenna port field values, wherein, for each antenna port field value, the DMRS port mapping configuration comprises a first mapping between a first codeword corresponding to a first transmission-reception point and a first code-division multiplexing group, and a second mapping between a second codeword corresponding to a second transmission-reception point and a second code-division multiplexing group;
transmit, to the UE, second control signaling that indicates an antenna port field value from the plurality of antenna port field values;
transmit, to the UE and based at least in part on the antenna port field value, a first DMRS comprising the first codeword, wherein the first DMRS is transmitted via a first set of DMRS ports corresponding to the first code-division multiplexing group in accordance with the first mapping; and
transmit, to the UE and based at least in part on the antenna port field value, a second DMRS comprising the second codeword, wherein the second DMRS is transmitted via a second set of DMRS ports corresponding to the second code-division multiplexing group in accordance with the second mapping.

28. The apparatus of claim 27, wherein the instructions are further executable by the processor to cause the apparatus to:
receive, from the UE, capability signaling indicating a capability of the UE to communicate with the base station in accordance with the DMRS port mapping configuration, wherein the first control signaling, the second control signaling, or both, are transmitted based at least in part on the capability signaling.

29. The apparatus of claim 28, wherein the instructions are further executable by the processor to cause the apparatus to:
receive, via the capability signaling, an indication of one or more frequency bands, one or more component carriers, or both, which are associated with the capability of the UE to communicate in accordance with the DMRS port mapping configuration, wherein the first DMRS, the second DMRS, or both, are transmitted within the one or more frequency bands, the one or more component carriers, or both.

30. The apparatus of claim 27, wherein the instructions are further executable by the processor to cause the apparatus to:
reference one or more port mapping tables associated with the DMRS port mapping configuration based at least in part on the antenna port field value; and
identify the first set of DMRS ports and the second set of DMRS ports based at least in part on referencing the one or more port mapping tables.
